(19) United States
(12) Patent Application Publication
(10) Pub. No.: US 2024/0323171 A1
(43) Pub. Date: Sep. 26, 2024

(54) PERSONALIZATION OF A SECURITY APPLET ON A MOBILE TERMINAL

(71) Applicant: Bundesdruckerei GmbH, Berlin (DE)

(72) Inventors: Frank DIETRICH, Berlin (DE); Matthias SCHWAN, Berlin (DE)

(73) Assignee: Bundesdruckerei GmbH, Berlin (DE)

(21) Appl. No.: 18/556,448

(22) PCT Filed: Apr. 1, 2022
(86) PCT No.: PCT/EP2022/058740

§ 371 Date: May 10, 2024

(30) Foreign Application Priority Data
Apr. 21, 2021 (DE) 10 2021 110 142.5

(51) Int. Cl. H04L 9/40; H04L 9/32

(52) U.S. Cl. CPC H04L 63/0478; H04L 9/3213; H04L 63/045

(57) ABSTRACT

The invention relates to a method for personalising a security applet (114) installed on a first security element (112) of a mobile terminal (100). The personalisation comprises:
establishing an encrypted communication channel (160) between the mobile terminal (100) and a personalisation server (220) via a network (150),
establishing a first encrypted subchannel (162) between an ID token (200) and the personalisation server (220) within the encrypted communication channel (160) via the mobile terminal (100),
reading out one or more of the first attributes (206) from the ID token (200) by the personalisation server (220) via the first encrypted subchannel (162) within the encrypted communication channel (160),
establishing a second encrypted subchannel (164) between the security applet (114) of the first security element (112) and the personalisation server (220) within the encrypted communication channel (160),
receiving, by the security applet (114) of the first security element (112), the read-out first attributes (206) from the personalisation server (220) via the second encrypted subchannel (164) within the encrypted communication channel (160).

The invention relates to a method for personalising a security applet installed on a security element of a mobile terminal device, as well as to a mobile terminal device and a system for carrying out the method.

Mobile terminals, such as smartphones, are ubiquitous. They are used in many areas of life and situations to fulfil a wide range of digital tasks or with the aid of digital tools. The same mobile terminals are used both in areas with low security requirements and in areas with high security requirements.

Mobile terminals must therefore be able to fulfil such high security requirements. The security of mobile terminals, such as smartphones, has therefore become a relevant requirement for the manufacturers of the devices, for the manufacturers of the programs installed on the devices and for providers of services that may be used with the devices. In order to ensure the security of use, a secure assignment of the mobile terminal to a user of the device is of great importance. From the point of view of program manufacturers and service providers, it is particularly difficult to implement a uniformly high security standard for devices from different manufacturers.

The object of the invention is to create an improved method for personalising a security applet.

The object forming the basis of the invention is achieved in each case by the features of the independent claims. Embodiments of the invention are given in the dependent claims.

Embodiments comprise a method for personalising a security applet installed on a first security element of a mobile terminal device using a first ID token and a personalisation server. An ID application program to which the security applet is assigned is installed on the mobile terminal. The first attributes of a user are stored in the first ID token.

The personalisation comprises:
establishing an encrypted communication channel between the mobile terminal and the personalisation server via a network, using the ID application program to establish the encrypted communication channel,
establishing a first encrypted subchannel between the first ID token and the personalisation server within the encrypted communication channel via the mobile terminal, using the ID application program to establish the first encrypted subchannel,
reading out one or more of the first attributes from the first ID token by the personalisation server via the first encrypted subchannel within the encrypted communication channel,
establishing a second encrypted subchannel between the security applet of the first security element and the personalisation server within the encrypted communication channel, using the ID application program to establish the second encrypted subchannel,
receiving, by the security applet of the first security element, the read-out first attributes from the personalisation server via the second encrypted subchannel within the encrypted communication channel,
storing the received first attributes by the security applet, wherein the ID application program is configured to use the first attributes to prove the identity of the user to another computer system.

Embodiments may have the advantage that a security element is provided on a mobile terminal, which enables a manufacturer of an application program to personalise the corresponding security element for the corresponding application. A corresponding personalisation comprises, for example, the insertion of cryptographic keys into the security element, which are assigned to the application program installed on the individual mobile terminal. Furthermore, in the course of personalisation, attributes of a user of the mobile terminal, for example, may be introduced into the corresponding security element. In this way, the corresponding security element and the application program installed on the corresponding terminal are assigned to a specific user. At the same time, the corresponding application program may be provided with individual key material for executing cryptographic protocols, which may be used, for example, to identify the corresponding application program to the user. For example, a security applet is installed on the security element for this purpose. The corresponding security applet is assigned to the corresponding application program and manages the corresponding cryptographic elements and protocols, such as cryptographic keys, for it. The application program is, for example, an ID application program that is configured to verify the identity of the user of the mobile terminal. For this purpose, the ID application program may use attributes of the user that identify the corresponding user. These attributes represent an electronic identity of the user. The corresponding attributes and thus the electronic identity of the user are provided, for example, by an ID token, i.e. an electronic identity document. In the course of personalising the security element or the security applet assigned to the ID application program, for example, attributes are read from the electronic identity document and stored on the security element for the ID application program. The resulting electronic identity of the user, which is provided by the mobile terminal, is therefore a derived identity derived from the electronic identity document. The corresponding electronic identity document may in particular be a sovereign identity document, such as an electronic identity card or an electronic passport.

Embodiments may have the advantage that in the course of such a derivation it may be ensured that the derived identity in the form of the attributes stored on the security element are actually stored on a security element bound to the user. In other words, embodiments may have the advantage that a binding of the security element and thus of the corresponding attributes to the actual owner of the corresponding attributes may be guaranteed. It is thus possible to prevent an unauthorised user from gaining access to attributes of another user and using them to identify themselves with a falsified electronic identity. In the case of proof of identity with the mobile terminal, it is therefore advantageous to ensure that the attributes presented with the proof of identity are actually attributes of the identified user. For this purpose, the transmission path for reading out the corresponding attributes, i.e. the electronic identity of an identity document, is ensured with a transmission path for personalising the derived identity, i.e. the insertion of the read-out attributes into a security element of a mobile terminal device using cryptographic means. This ensures that the mobile terminal used to read the attributes is the same mobile terminal of which the security elements are personalised with the read-out attributes.

For example, the user must authenticate themselves to the ID token when reading out the ID token using the mobile terminal. This ensures that the user initiating or confirming the readout is actually the owner of the corresponding ID document. Furthermore, the user must authenticate themselves to the mobile terminal during the personalisation of the security element of the mobile terminal, i.e. during the insertion of the read-out attributes. This ensures that the user initiating or confirming the personalisation is actually the owner of the mobile terminal or the user registered on this mobile terminal. The fact that the transmission paths for reading out the attributes and for inserting the attributes or for personalisation are also linked by cryptographic means ensures that the mobile terminal used for reading out and inserting the attributes is the same mobile terminal assigned to the same user. If the corresponding user has to authenticate themselves to both the mobile terminal and the ID token when the attributes are read out, it may be ensured, for example, that the holder of the ID token is the same person as the owner of the mobile terminal. At the very least, it may be ensured that the holder of the ID token gives their consent together with the owner of the mobile terminal during the readout process and that at least the consent of the owner of the same mobile terminal is required to insert the corresponding attributes. In this way, it may be ruled out that in the course of reading out and inserting attributes, the mobile terminal device used may be exchanged and the corresponding attributes may thus come under the control of another user, in particular an unauthorised user. This effectively prevents misuse. To cryptographically bind the transmission path for reading out the attributes to the transmission path for personalising or inserting the attributes, an encrypted communication channel is established between the mobile terminal and a personalisation server that performs the personalisation. This communication channel is encrypted so that it may be ensured that communication via this channel is actually only possible between the two participants who initially established the corresponding communication channel, i.e. the mobile terminal and the personalisation server. In particular, end-to-end encryption may be used for this purpose. For example, encryption is carried out on the mobile terminal using a further security element of the mobile terminal, which is assigned to an operating system of the mobile terminal, for example, and is configured to establish encrypted communication channels independently of the first security element with the security applet to be personalised. The reading from the ID token on the one hand and the insertion of the read-out attributes into the security element to be personalised in the course of personalisation on the other are each carried out via an independent encrypted subchannel of the encrypted communication channel, for example. The encrypted subchannels make it possible to ensure that only participants who have set up the corresponding subchannel and have the corresponding cryptographic keys may communicate with each other via these subchannels. In the case of the first encrypted subchannel between the ID token and the personalisation server, these are the corresponding ID token and the personalisation server. In the case of the second encrypted subchannel between the security applet of the first security element to be personalised and the personalisation server, these are the corresponding security applet to be personalised and the personalisation server.

The subchannels are encrypted subchannels within the encrypted communication channel. In each case, the transmitted data is encrypted twice. On the one hand, the corresponding data is encrypted by the ID token in the course of reading it out from the ID token from a channel-specific ephemeral symmetric cryptographic session key assigned to the corresponding encrypted subchannel. During the transmission of the corresponding encrypted data between the mobile terminal and the personalisation server, it is additionally encrypted a second time by the mobile terminal using a channel-specific ephemeral symmetric cryptographic session key of the encrypted communication channel. The receiving personalisation server must therefore first decrypt the encryption of the communication channel and then decrypt the encryption of the corresponding subchannel in order to gain access to the transmitted data.

During personalisation, the personalisation server uses the same encrypted communication channel throughout. This means that the attributes used for personalisation are encrypted with the channel-specific ephemeral symmetric cryptographic session key of the encrypted communication channel. Since only the mobile terminal already used to read the attributes, for example its other security element, is in possession of the same channel-specific ephemeral symmetric cryptographic session key, only the same mobile terminal is able to decrypt the attributes to be used for personalisation. This ensures that the same mobile terminal that was previously used to read the corresponding attributes is used for personalisation. To ensure secure transmission of the attributes to be used for personalisation to the security element of the mobile terminal to be personalised, a further encrypted subchannel within the encrypted communication channel is used to transmit the attributes. In other words, the corresponding attributes are first encrypted with an ephemeral symmetric cryptographic session key of the corresponding subchannel and then with the channel-specific ephemeral symmetric cryptographic session key of the encrypted communication channel. The attributes encrypted twice in this way are first decrypted by the mobile terminal forming the end point of the encrypted communication channel, for example by a further security element of the terminal managing the ephemeral cryptographic session key required for this. The data resulting from this first decryption is forwarded to the security element with the security applet of the corresponding ID application program to be personalised. The corresponding security applet has the cryptographic session key, which is assigned to the corresponding subchannel, the endpoint of which is formed by the security applet, for example. This cryptographic session key may also be used to decrypt the second encryption of the transmitted data, which may then be used for personalisation by the security element to be personalised.

For example, a secure connection is first established in the form of an encrypted communication channel from the mobile terminal to the personalisation server. The corresponding connection is secured, for example, by mutual authentication or authentication, which enables the participants to ensure with whom they are communicating. Authentication on the part of the mobile terminal may require authentication of the user of the mobile terminal to the mobile terminal. This not only ensures that the communication takes place in the communication channel with or via the mobile terminal, but also that the communication takes place with the consent of the user of the mobile terminal. For this purpose, the corresponding user provides an authentication factor, for example, such as a biometric feature or a PIN, in particular a system PIN. The corresponding authentication factor is recorded, for example, by an authentication sensor of the mobile terminal in the form of authentication data. This may be a biometric sensor, such as a finger scanner or a camera for detecting the user. For example, the corresponding authentication sensor may also be an input device on the mobile terminal that the user may use to enter their PIN, such as a keyboard or a touchscreen. A system PIN is, for example, a PIN assigned to the operating system of the corresponding mobile terminal. To read out attributes from the ID token, i.e. the user's electronic identity document, the user must also be authenticated to the ID token as part of setting up the subchannel. For this purpose, the user can, for example, provide a corresponding authentication factor via the authentication sensor of the mobile terminal. Alternatively, the corresponding authentication factor may also be provided directly to the ID token if the ID token has the authentication sensor for detecting the corresponding authentication factor. As before, the corresponding authentication factor may be, for example, biometric features of the user or, in particular, a document PIN. A corresponding document PIN is a PIN that is assigned to the corresponding ID token or electronic identity document. To transmit the attributes read from the ID token to the personalisation server, an encrypted subchannel of the encrypted communication channel is set up. The corresponding setup is carried out via the encrypted communication channel, for example. The attributes to be read are then transferred securely from the personalisation server to the mobile terminal or the security applet of the ID application program to be personalised using double encryption.

To personalise the security applets of the ID application program to be personalised on the first security element, a second subchannel is set up within the encrypted communication channel. This requires, for example, authentication of the user to the security applet to be personalised. Authentication is carried out, for example, using a further security element, which is a security element assigned to the operating system of the mobile terminal. The user authenticates themselves to the corresponding additional security element or is successfully authenticated by the corresponding additional security element. The further security element communicates the successful authentication of the user to the security applet to be personalised on the security element. The corresponding notification may be made using a challenge-response procedure, for example. In this way, the user is also successfully authenticated to the security applet of the mobile terminal to be personalised. Upon successful authentication of the user to the security applet to be personalised on the first security element using the additional security element, an encrypted subchannel is established between the security applet to be personalised on the first security element and the personalisation server via the encrypted communication channel. The encrypted subchannel is, for example, an end-to-end encrypted subchannel. The previously read data, i.e. attributes, from the ID token are now transmitted via the second subchannel within the communication channel to the security applet to be personalised on the security element. Further cryptographic elements, such as cryptographic keys, may also be transmitted to the security applet to be personalised via the corresponding subchannel. The corresponding cryptographic keys are, for example, the attribute-specific and thus identity-specific cryptographic keys, which are assigned to the derived electronic identity of the user of the mobile terminal stored on the mobile terminal in the course of personalisation.

A method for the secure personalisation of a mobile terminal or an ID application program installed on the mobile terminal with identity information of a user who is bound to the mobile terminal, whereby the security applet is in particular independent of the device manufacturer. A correspondingly personalised mobile terminal enables user authentication to a device manufacturer-independent security applet, for example for the purpose of identification and/or authentication by an ID provider server to third-party service providers.

A security element is a secured element of a mobile terminal that provides cryptographic means. These cryptographic means are protected against manipulation and are only accessible to authorised services and applications via cryptographic keys, for example. In particular, the cryptographic means may only be introduced, added to, changed and/or deleted in the security element by authorised services and applications, for example. A security element therefore provides a tamper-proof platform, for example implemented in the form of a secure single-chip microcontroller, on which applets and/or confidential and/or cryptographic data may be stored according to predefined rules and security requirements by reliably identified trusted instances and thus made available to authorised application programs and/or operating systems. A security element may be embedded or integrated, for example non-destructively detachable or firmly connected, i.e. not non-destructively detachable. A security element may be implemented in the form of a secure element (SE), for example. The security element can, for example, comprise a SIM, UICC, SmartMicroSD, smartcard, eSE, eSIM or eUICC. For example, cryptographic keys are stored on a security element, i.e. the security element comprises a data vault for cryptographic keys or a “key store”. Such a key store or security element may also be implemented as part of the main processor, for example in a TEE (Trusted Execution Environment). For example, the security element may be implemented using a TEE. Security elements are implemented, for example, as hardware and/or firmware. According to embodiments, security elements or key stores may also be implemented as software. For example, two security elements are independent of each other if there is no common instance that is authorised to access both security elements.

An application program, also known as an application or app for short, is a computer program that provides, supports and/or enables the processing of non-system functionality.

An applet is understood to be a computer program that is not operated as a stand-alone application program. The term “applet” is made up of the words “application” and “snippet”.

An operating system refers to a computer program or a combination of computer programs that provide, support and/or enable the processing of system functions. System resources are made available by an operating system. System resources refer to system elements or hardware components of a computer that are required by processes for correct execution.

A computer or computer system may be, for example, a stationary computer, such as a personal computer (PC), service terminal or server, or a mobile portable computer, such as a laptop, tablet, smartphone or other smart device. The computer may comprise an interface for connection to the network, whereby the network may be a private or public network, in particular the Internet. Depending on the embodiment, this connection may also be established via a mobile phone network.

A “service provider server” or service server is understood here to be a server or a computer system on which a server program is executed and which provides the option of initiating or using and/or executing an offered service via a network.

A “personalisation server” is a server or a computer system on which a server program is executed and which is configured to read out attributes from an ID token and insert them into a mobile terminal.

An “ID token” is understood here to be a portable electronic device, for example a so-called USB stick, a chip card, or a document on which attributes of a user are stored. A “document” is understood in particular to be an identification, value or security document, in particular a sovereign document, in particular a paper-based and/or plastic-based document, such as an electronic identification document, in particular a passport, identity card, visa, driving licence, vehicle registration document, vehicle registration document, health card, or a company ID card, or another ID document, a chip card, means of payment, in particular a banknote, bank card or credit card, consignment note or other proof of authorisation. In particular, the ID token may be a machine-readable travel document, such as those standardised by the International Civil Aviation Organisation (ICAO) and/or the German Federal Office for Information Security (BSI).

A “provisioning server” is a server or computer system on which a server program is executed and which is configured to provision a mobile terminal, in particular with cryptographic keys.

A “personalisation server” is a server or computer system on which a server program is executed and which is configured to read out attributes from an ID token and insert them into a mobile terminal.

An “ID provider server” is understood to be a server or computer system on which a server program is executed and which is configured to provide attributes of an electronic identity provided by the mobile terminal for a service provider server and/or to confirm them to the service provider server.

A “program” or “program instructions” is understood here without restriction to mean any type of computer program that comprises machine-readable instructions for controlling a functionality of the computer.

The term “processor” is used here and in the following to refer to a logic circuit that is used to execute program instructions. The logic circuit may be implemented on one or more discrete components, in particular on a chip. In particular, a “processor” is understood to mean a microprocessor or a microprocessor system comprising several processor cores and/or several microprocessors.

The term “memory” is used here to refer to both volatile and non-volatile electronic memories or digital storage media.

A “non-volatile memory” is understood here to be an electronic memory for the permanent storage of data, in particular static cryptographic keys, attributes or identifiers. A non-volatile memory may be configured as a non-changeable memory, which is also known as read-only memory (ROM), or as a changeable memory, which is also known as non-volatile memory (NVM). In particular, this may be an EEPROM, for example a flash EEPROM, or flash for short. A non-volatile memory is characterised by the fact that the data stored on it is retained even after the power supply is switched off.

An “interface” or “communication interface” is understood here to mean an interface via which data may be received and sent, whereby the communication interface may be configured to be contact or contactless. A communication interface can, for example, enable communication via a network. Depending on the configuration, a communication interface can, for example, provide wireless communication in accordance with a mobile radio standard, Bluetooth, RFID, WiFi and/or NFC standard. Depending on the configuration, a communication interface can, for example, provide cable-based communication. The communication interface may be an internal interface or an external interface.

The encrypted communication channels are, for example, encrypted end-to-end connections. An “encrypted end-to-end connection” or an “encrypted end-to-end transmission channel” is understood here to mean a connection between a transmitter and a receiver with end-to-end encryption, in which the data to be transmitted is encrypted by the transmitter and only decrypted again by the receiver. The encryption of transmitted data thus takes place across all transmission stations, so that intermediate stations cannot gain knowledge of the content of the transmitted data due to the encryption. The connection is cryptographically secured by the encryption in order to prevent spying and/or manipulation of the transmission, whereby a so-called secure messaging procedure may be used for this purpose. End-to-end encryption is based, for example, on two symmetric cryptographic keys, whereby a first of the symmetric keys is used to encrypt messages and a second of the symmetric keys is used to authenticate the sender of the message, for example by means of Message Authentication Code (MAC) algorithms. For example, ephemeral keys for encryption are negotiated for an encrypted communication channel in the course of setting it up, which lose their validity when the communication channel is terminated. Using different ephemeral keys for different communication channels makes it possible to operate a number of communication channels in parallel.

An encrypted communication channel may be set up using the Transport Layer Security (TLS) protocol, for example, as part of the Hypertext Transfer Protocol Secure (HTTPS) protocol.

Asymmetric key pairs are used for a variety of cryptosystems and play an important role in the secure transmission of electronic data. An asymmetric key pair consists of a public cryptographic key, which is used to encrypt and/or decrypt data and may be passed on to third parties, for example to a sender or recipient of data, and a private cryptographic key, which is used to encrypt and/or decrypt but also to sign data and must generally be kept secret. The public key enables anyone to encrypt data for the holder of the private cryptographic key or to verify digital signatures created with the private cryptographic key. A private key enables its holder to decrypt data encrypted with the public cryptographic key or to create digital signatures for data.

A digital signing of data comprises, for example, forming a check value of the data, such as a hash value, which is encrypted with a private cryptographic key of an asymmetric key pair used as a signature key. In the case of a signature, only the signatory knows the private cryptographic key used to create the signature, i.e. the signature key of the asymmetric key pair used for the signature. The signature recipient only has the public cryptographic key, i.e. the signature verification key, of the asymmetric key pair used for the signature. The signature recipient may therefore verify the signature, but cannot calculate it itself. For a signature check, for example, the signature recipient calculates the check value of the signed data and compares this with the result of decrypting the signature using the signature verification key. If the calculated hash value matches the result of the decryption, the signature is correct. If the authenticity of the signature verification key is also confirmed, for example by a certificate, in particular a PKI certificate, the signature is valid.

The term “certificate” is used here to refer to a digital certificate, which is also known as a public key certificate (PKI certificate). A certificate is structured data that is used to assign a public cryptographic key of an asymmetric cryptosystem to an identity, such as a person, institution or device. For cryptographic security and to prove the authenticity of the certificate data, these are signed by a certificate issuer. PKI certificates, which are based on asymmetric key pairs and, apart from a root certificate, are each signed by a certificate issuer with a signature key of which the associated signature verification key is assigned to the certificate issuer by a PKI certificate of the corresponding certificate issuer, are used to realise a so-called Public Key Infrastructure (PKI). For example, the certificate may correspond to the X.509 standard or another standard. For example, the certificate is a Card Verifiable Certificate (CVC). An authorisation certificate comprises structured data that also defines the rights of the identity.

The PKI provides a system for issuing, distributing and verifying digital certificates. In an asymmetric cryptosystem, a digital certificate may confirm the authenticity of a public cryptographic key and its authorised scope of application and validity. The digital certificate itself is protected by a digital signature, the authenticity of which may be verified using the public cryptographic key of the issuer of the certificate. A digital certificate is used to check the authenticity of the issuer's key. In this way, a chain of digital certificates may be created, each of which confirms the authenticity of the public cryptographic key with which the previous certificate may be checked. Such a chain of certificates forms a so-called validation path or certification path. The participants in the PKI must be able to rely on the authenticity of the last certificate, the so-called root certificate, and the key certified by it, for example, without another certificate. The root certificate is managed by a so-called root certification authority, the authenticity of all certificates in the PKI is based on its assumed authenticity.

Digital certificates are confirmed, for example, by an independent, credible authority (certification service provider/ZDA or trust service provider/VDA), i.e. the certification authority issuing the certificate. Certificates may be made available to a wide range of people to enable them to check the authenticity and validity of electronic signatures. A certificate may be assigned to an electronic signature and provide a signature verification key in the form of the public cryptographic key if the private key associated with the signature verification key was used as the signature key. By making a certificate available to the general public in association with a public cryptographic key, a CSP/VSP enables users of asymmetric cryptosystems to assign the public cryptographic key to an identity, for example a person, an organisation or a computer system.

Embodiments may have the advantage that they enable secure management of digital or electronic identities using a mobile terminal. For this purpose, the application program may be configured as an ID application program for managing electronic identities or identity attributes belonging to electronic identities or defining electronic identities. For example, a secure application program or application for managing electronic identities is provided, which is referred to below as an ID application program.

At least one security applet is assigned to the ID application program, which is installed and executed on the mobile terminal. The security applet is installed on the first security element of the mobile terminal and is executed there. The mobile terminal with the electronic identities managed by the ID application program may be used, for example, for identification and authentication, for transferring identity data and for supporting declarations of intent in a mobile context.

According to embodiments, the electronic identity may comprise an officially recognised identity, such as an electronic identity created on the basis of an official identification document, such as an identity card or passport.

The electronic identity of a user is unique, i.e. unique and unmistakable. It is defined on the basis of characteristics, so-called identity attributes. An electronic identity comprises, for example, personal data. Personal data refers to data that enables a person to be identified or may be assigned to a person to whom the personal data relates.

A user may have a number of different, application-specific electronic identities. These electronic identities may fulfil different security requirements.

According to embodiments, an electronic identity stored on the mobile terminal and provided or managed by the ID application program may be used to identify and authenticate the user of the mobile portable terminal without additional hardware besides the mobile terminal.

Identity attributes are requested, for example, by service providers or service providers for online services. According to embodiments, the identity attributes required by a service provider for its online service are transmitted in encrypted and authentic form. For example, authorisation certificates are used to regulate who may access which identity attributes or has read authorisation for them. For example, the required identity attributes are read by an ID provider authorised to do so by means of an authorisation certificate and made available to the requesting service provider by the ID provider. According to embodiments, the ID provider only provides the requesting service provider with a confirmation of the requested identity attribute(s). For example, the service provider asks whether the requested identity attributes have one or more characteristics, which is checked by the ID provider server using the identity attributes read out and either confirmed or denied to the service provider.

The user's consent to use the identity attributes and/or user authentication is obtained, for example, by checking one or more authentication factors, such as password, PIN, fingerprint or facial recognition.

According to embodiments, the ID application program controls the establishment of the encrypted communication channel between the mobile terminal and the personalisation server. For example, the ID application program comprises a personalisation component that controls the personalisation on the side of the mobile terminal. For example, the personalisation component of the ID application program controls the establishment of the encrypted communication channel on the mobile terminal and the establishment of the first encrypted subchannel and the second encrypted subchannel via the mobile terminal.

For example, the first attributes received are stored in the first security element by the security applet. For example, the attributes are stored in a memory area of the first security element assigned to the security applet or the ID application program.

For example, together with the first attributes, the personalisation server sends a request to the first security element to store the first attributes. For example, the request is sent to the security applet of the first security element in the form of a CAPDU (Commando Application Protocol Data Unit).

According to embodiments, the encrypted communication channel is encrypted with a first channel-specific ephemeral symmetric cryptographic session key. According to embodiments, the first encrypted subchannel is encrypted with a second channel-specific ephemeral symmetric cryptographic session key. According to embodiments, the second encrypted subchannel is encrypted with a third channel-specific ephemeral symmetric cryptographic session key.

Embodiments may have the advantage that the encryption in the communication channel and in the two encrypted subchannels are each assigned channel-specific ephemeral symmetric cryptographic session keys. Thus, the subchannels may each be combined with the communication channel or executed within the same by using double encryption by the cryptographic session keys assigned to the corresponding channels.

According to embodiments, the first channel-specific ephemeral symmetric cryptographic session key, the second channel-specific ephemeral symmetric cryptographic session key and the third channel-specific ephemeral symmetric cryptographic session key are each independent of each other.

For example, the first and second encrypted subchannels are also each assigned a channel-specific ephemeral symmetric cryptographic authentication key for authenticating data that is transmitted via the corresponding first or second encrypted subchannel. For example, a MAC is generated for the corresponding data using the respective channel-specific ephemeral symmetric cryptographic authentication key. The corresponding authentication keys are, for example, cryptographic keys for generating the corresponding MAC.

For example, a MAC is calculated using a MAC algorithm, which is provided with data to be protected, e.g. the identity attributes, and a cryptographic key, e.g. a symmetric cryptographic key, as input data. Using this input data, the MAC algorithm calculates a checksum, which serves as the MAC. Block ciphers or hash functions, for example, may be used to calculate MACs. For example, an HMAC (Keyed-Hash Message Authentication Code) may be used as a MAC, for the construction of which a cryptographic hash function, such as the Secure Hash Algorithm (SHA), and a secret cryptographic key, such as a symmetric cryptographic key, are used.

To secure a data transfer, for example a transfer of identity attributes, a cryptographic key, for example a symmetric cryptographic key, is agreed between the sender, for example the ID token, and the receiver, for example a personalisation server. The sender uses this cryptographic key to calculate a MAC for the data to be transmitted and sends the calculated MAC together with the data to be transmitted to the receiver. The receiver in turn calculates a MAC for the received data using the cryptographic key and compares the result with the received MAC. If the calculated MAC and the received MAC match, the integrity check is successful and the received data is considered authentic.

In the case of a MAC, both the sender and the recipient must have knowledge of the cryptographic key used, in contrast to the use of pure hash functions or signatures. In the case of pure hash functions, for example, no cryptographic keys are used. If the hash functions are public, anyone may calculate the hash value, especially for manipulated messages. In the case of a signature, only the signatory knows the private cryptographic key used to create the signature, i.e. the signature key of an asymmetric key pair used for the signature. The signature recipient only has the public cryptographic key, i.e. the signature verification key, of the asymmetric key pair used for the signature. The signature recipient may therefore verify the signature using the signature verification key, but cannot calculate it itself.

According to embodiments, the encryption of the encrypted communication channel is an end-to-end encryption between the mobile terminal and the personalisation server.

Embodiments may have the advantage that it may be ensured that the same mobile terminal always forms an end point of the encrypted communication channel. This means that as long as communication takes place via the same encrypted communication channel, the personalisation server knows that it is communicating with the same mobile terminal. This ensures that the mobile terminal via which the ID token is read is the same mobile terminal that is personalised with the read data, i.e. attributes of the ID token.

According to embodiments, the encryption of the encrypted communication channel is performed by the mobile terminal using a second security element of the mobile terminal, which is associated with an operating system of the mobile terminal. The second security element provides, for example, cryptographic keys and/or cryptographic protocols for the operating system.

According to embodiments, the encryption of the first encrypted subchannel is an end-to-end encryption between the first ID token and the personalisation server.

Embodiments may have the advantage that the encrypted data transmitted between the ID token and the personalisation server may be transmitted at least between the mobile terminal and the personalisation server within the encrypted communication channel. At the same time, the mobile terminal does not yet have access to the data transmitted via the encrypted subchannel at this point. This ensures that the corresponding data may only be accessed by the personalisation server in the course of personalisation. This means that misuse or unauthorised reading of attributes may be prevented. In fact, the attributes may only be read and used for personalisation via a trusted instance in the form of the personalisation server.

According to embodiments, the encryption of the second encrypted subchannel is an end-to-end encryption between the security applet and the personalisation server.

Embodiments may have the advantage that the end-to-end encryption between the security applet of the security element to be personalised and the personalisation server may ensure that the security applet of the first security element of the mobile terminal to be personalised is actually personalised and that the data used for personalisation is only made available to the corresponding security applet. In this way, unauthorised access to the corresponding personalisation data may be prevented, for example.

According to embodiments, the personalisation further comprises:
generating an asymmetric cryptographic key pair associated with the ID application program by the security applet, comprising a private cryptographic key and a public cryptographic key of the ID application program, wherein the asymmetric key pair is used to authenticate the ID application program in the course of using the first attributes,

According to embodiments, the security applet sends the public cryptographic key of the ID application program to the personalisation server via the second encrypted subchannel within the encrypted communication channel.

Embodiments may have the advantage that the security applet on the first security element may generate an individual asymmetric key pair for the individual ID application program and make it available for use by the ID application program. For example, the asymmetric key pair is assigned to the individual electronic identity, which is introduced into the mobile terminal in the course of personalisation. The public cryptographic key of the corresponding asymmetric key pair is transmitted via the encrypted subchannel between the security applet and the personalisation server in the encrypted communication channel. This means that the corresponding public cryptographic key, which is generated on the personalised security element during personalisation, is made available to the personalisation server. The personalisation server may make the corresponding public cryptographic key available to other instances, for example as a signature verification key. The corresponding signature verification key may be used to ensure that data signed with the associated private cryptographic key actually originates from the personalised security applet of the first security element. For example, the personalisation server may issue a certificate for or with the corresponding public cryptographic key. The personalisation server may confirm the authenticity of the corresponding public cryptographic key or its assignment to the personalised security element and thus to the corresponding personalised ID application program by means of the corresponding certificate, which is, for example, a certificate of a certificate chain, in particular a PKI.

For example, to initiate the generation of the asymmetric cryptographic key pair assigned to the ID application program, the personalisation server sends a request to the security applet of the first security element, which prompts the security applet to generate the asymmetric cryptographic key pair assigned to the ID application program. For example, the request is sent to the security applet of the first security element in the form of a CAPDU.

According to embodiments, the personalisation further comprises:
receiving one or more root signature verification keys by the security applet from the personalisation server via the second encrypted subchannel within the encrypted communication channel, wherein the received root signature verification keys are for verifying certificate signatures of one or more root instances having certificates each used in the course of a readout of the first attributes for authenticating a readout computer system to the ID application program,
storing the received root signature verification keys by the security applet in the first security element.

Embodiments may have the advantage that root signature verification keys may be stored in the security applet in the course of personalisation on the corresponding security element. The corresponding root signature verification keys enable the security applet to verify signatures of root instances, in particular certificate signatures of root instances. If a certificate chain is presented to the ID application program and thus to the security applet for authenticating a computer system, for example a computer system that wishes to access the attributes read out and stored in the personalised security element to verify the identity of the user of the mobile terminal. The root signature verification key can, for example, be used to verify a first initial certificate issued within the certificate chain of the corresponding certificate chain. If the corresponding root certificate proves to be authentic, the authenticity of the complete certificate chain may be successively checked and verified. For example, each certificate in the certificate chain is signed using a private cryptographic key of an issuing authority as a signature key. The corresponding signature can, for example, be verified by an associated public cryptographic key provided by the preceding certificate as a signature verification key. Only the output certificate, which is not preceded by a certificate, is signed with a root signature key of a root instance. This root signature may be checked and verified using a corresponding root signature verification key stored in the personalised security element.

For example, together with the one or more root signature verification keys, the personalisation server sends a request to the security applet of the first security element to store the root signature verification keys. For example, the request is sent to the security applet of the first security element in the form of a CAPDU.

According to embodiments, the personalisation further comprises:
receiving a signature of the first attributes from the personalisation server by the security applet of the first security element via the second encrypted subchannel within the encrypted communication channel, the signature serving as proof of authenticity of the first attributes,
storing the received signature of the first attributes by the security applet in the first security element.

Embodiments may have the advantage that their authenticity may be verified by means of the corresponding signature of the attributes. Consequently, the mobile terminal device, which comprises a corresponding signature of the attributes used for personalisation, may also be used offline to verify the identity of the user of the mobile terminal device. For this purpose, the mobile terminal displays the corresponding attributes including the signature on a display device, for example, in the form of a one-or two-dimensional readable machine code, such as a QR code. The corresponding attributes with the signature may then be captured by a reader, for example, and verified using the signature. Furthermore, contactless transmission of the corresponding attributes with the signature to prove the identity of the user of the mobile terminal to another computer system, for example another mobile terminal, would also be possible, for example. In this case too, the authenticity of the corresponding attributes and thus the identity of the user of the mobile terminal could be verified using the signature.

For example, together with the signature of the first attributes, the personalisation server sends a request to the security applet of the first security element to store the signature of the first attributes. For example, the request is sent to the security applet of the first security element in the form of a CAPDU.

According to embodiments, establishing the encrypted communication channel comprises negotiating the first channel-specific ephemeral symmetric cryptographic session key.

According to embodiments, negotiating the first channel-specific ephemeral symmetric cryptographic session key:
generating a first random value by the mobile terminal,
generating the first channel-specific ephemeral symmetric cryptographic session key using the first random value by the mobile terminal,
receiving a first certificate of the personalisation server with a first public cryptographic key of a first asymmetric cryptographic key pair of the personalisation server by the mobile terminal from the personalisation server,
encrypting the first random value using the received first public cryptographic key of the personalisation server by the mobile terminal,
sending the encrypted first random value to the personalisation server by the mobile terminal to generate the first channel-specific ephemeral symmetric cryptographic session key by the personalisation server.

Embodiments may have the advantage that a secure method for providing the first channel-specific ephemeral symmetric cryptographic session key for encrypting the communication channel between the mobile terminal and the personalisation server may be provided. For example, a first initial random value is first generated by the mobile terminal and sent to the personalisation server. After receiving the corresponding first initial random value, the personalisation server generates a second initial random value, which it sends to the mobile terminal. This means that both participants, the mobile terminal and the personalisation server, have both initial random values. Furthermore, the server sends its certificate to the mobile terminal, for example, and receives a certificate of the mobile terminal from the mobile terminal after a successful check of the corresponding certificate. The certificate of the mobile terminal can, for example, be a certificate assigned to the application program. The certificate of the mobile terminal received by the personalisation server is also verified. The two certificates each comprise a public cryptographic key, i.e. the certificate of the personalisation server comprises a public cryptographic key of an asymmetric key pair of the personalisation server and the certificate of the mobile terminal comprises a public cryptographic key of an asymmetric key pair of the mobile terminal. This means that both participants now each have public cryptographic keys from the other party, the authenticity of which is verified by a certificate in each case. The mobile terminal then generates the first random value, for example, which it sends to the personalisation server. This means that both participants in the communication now each have three random values from which, for example, the channel-specific ephemeral symmetric cryptographic session key may be calculated. Furthermore, the mobile terminal sends, for example, a signature of one, several or all previous messages exchanged in the course of establishing the channel to the personalisation server. By verifying the corresponding signature using the public cryptographic key provided in the certificate of the mobile terminal as a signature verification key, the personalisation server may authenticate the mobile terminal. If the personalisation server subsequently sends a message encrypted with the first channel-specific ephemeral symmetric cryptographic session key to the mobile terminal, the personalisation server is also authenticated with respect to the mobile terminal. The personalisation server may only calculate the first channel-specific ephemeral symmetric cryptographic session key if it has a private cryptographic key with which it may decrypt the first random value received from the mobile terminal. This means that only the personalisation server in possession of the corresponding private cryptographic key, to which the certificate of the personalisation server is assigned, is capable of encrypted communication via the encrypted communication channel.

According to embodiments, the establishment of the encrypted communication channel further comprises a mutual authentication of the ID application program and/or the mobile terminal and the personalisation server.

Embodiments may have the advantage that mutual authentication may be used to ensure which participants are communicating with each other and between which participants the encrypted communication channel is established. In particular, the identity of the mobile terminal may be determined and it may be ensured to which terminal the electronic identity of the user is assigned or which mobile terminal is personalised

According to embodiments, the mobile terminal further comprises a second security element. For example, the second security element is used on the mobile terminal device to authenticate the mobile terminal device or the application program. The second security element comprises a first initial private cryptographic key of a first initial asymmetric cryptographic key pair of the ID application program. Furthermore, the mobile terminal also comprises an initial certificate of the ID application program, which comprises the initial public cryptographic key of the initial asymmetric cryptographic key pair of the ID application program. For authentication to the personalisation server, the mobile terminal sends, for example, the initial certificate of the ID application program to the personalisation server as well as a message signed by the second security element with the first initial private cryptographic key of the ID application program.

Embodiments may have the advantage that the mobile terminal may authenticate itself to the personalisation server using the corresponding certificate of the ID application program.

According to embodiments, the mobile terminal further comprises one or more authentication sensors for detecting one or more authentication factors of the user. An operating system installed on the mobile terminal is configured to control the authentication sensor. The second security element is assigned to the operating system. The prerequisite for signing with the first initial private cryptographic key of the ID application program is successful authentication of the user against the second security element. The user is registered on the mobile terminal and at least one reference value of the registered user is stored in the second security element for verifying at least one authentication factor that has been recorded.

Embodiments may have the advantage of enabling authentication of a user of the mobile terminal. This authentication of the registered user is then, for example, a necessary prerequisite for successful authentication of the mobile terminal to the personalisation server. This ensures that a registered user agrees to the use of the mobile terminal to establish the encrypted communication channel.

According to embodiments, establishing the first encrypted subchannel comprises authenticating the user to the ID token via the mobile terminal.

Embodiments may have the advantage that when reading out the ID token, it may be ensured that a corresponding readout is authorised by the holder of the ID token. For example, the user is authenticated to the ID token using the mobile terminal.

According to embodiments, authenticating the user to the ID token comprises:
receiving, by the ID application program, a further authentication factor of the user detected by the one or more authentication sensors,
generating a symmetric cryptographic key by the second security element using the received further authentication factor,
receiving an encrypted second random value by the ID application program from the ID token, wherein the encrypted second random value is encrypted using the symmetric cryptographic key generated by the ID token using a further reference value of the registered user stored in the ID token for verifying the further authentication factor,
decrypting the received encrypted second random value by the second security element using the generated symmetric cryptographic key,
generating a first ephemeral asymmetric cryptographic key pair of the ID application program by the second security element, which comprises a first ephemeral private cryptographic key and a first ephemeral public cryptographic key of the ID application program,
sending the first ephemeral public cryptographic key of the ID application program to the ID token,
receiving an ephemeral public cryptographic key of the ID token,
generating a first secret shared with the ID token using the decrypted second random value, the first ephemeral private cryptographic key of the ID application program and the ephemeral public cryptographic key of the ID token,
generating a first shared authentication key for mutual authentication of the ID application program and ID token by the second security element using the shared first secret,
generating a first authentication token using the first authentication key and the first ephemeral public cryptographic key of the ID token by the second security element,
sending the first authentication token to the ID token by the second security element,
receiving a second authentication token from the ID token by the second security element,
verifying the received second authentication token using the first authentication key and the first ephemeral public cryptographic key of the ID application program.

For example, an ephemeral symmetric cryptographic key is derived using a recorded authentication factor of the user. The authentication factor recorded by the mobile terminal on the one hand and a reference value stored on the ID token on the other serve in each case as a shared password for deriving the ephemeral symmetric cryptographic key on both sides. The mobile terminal receives a random value from the ID token, which is encrypted with the same ephemeral symmetric cryptographic key. The ID token derives the corresponding ephemeral symmetric cryptographic key, for example, from a reference value for the authentication factor or the correspondingly derived ephemeral symmetric cryptographic key is stored on the ID token. If the mobile terminal is able to correctly decrypt the received encrypted random value, this is proof that the mobile terminal has the correct authentication factor. The mobile terminal generates an ephemeral asymmetric key pair, the public cryptographic key of which the mobile terminal sends to the ID token. In return, the mobile terminal receives the public cryptographic key of the ID token. No static cryptographic keys are therefore required at this point in the process; instead, only randomly generated ephemeral asymmetric key pairs may be used. The mobile terminal generates a secret shared with the ID token using the decrypted random value, the ephemeral private cryptographic key of the ID application program and the ephemeral public cryptographic key of the ID token. The ID token is also capable of calculating the corresponding secret using the random value it generates, the ephemeral private cryptographic key of the ID token and the ephemeral public cryptographic key of the mobile terminal received from the mobile terminal.

The mobile terminal device may now use the shared secret generated in this way to calculate a shared authentication key for mutual authentication of the ID application program and ID token. For example, the mobile terminal may generate a first authentication token using the corresponding authentication key and the ephemeral public cryptographic key of the ID token. The corresponding authentication token may be sent by the mobile terminal to the ID token, which may verify the received authentication token using the shared authentication key and the ephemeral private cryptographic key of the ID token. This allows the mobile terminal to authenticate itself to the ID token. In return, the ID token may also send an authentication token to the mobile terminal. The mobile terminal receives the authentication token, which is generated, for example, using the shared secret and the ephemeral public cryptographic key of the mobile terminal. The authentication token may be verified using the authentication key and the public cryptographic key of the ID application program.

According to embodiments, an application area identifier of an application area of the ID token is further used to generate the shared first secret, wherein the application area identifier is received together with the encrypted second random value from the ID token by the ID application program.

According to embodiments, the first authentication key is a cryptographic key for generating a message authentication code, wherein the first authentication token is a first MAC of the first ephemeral public cryptographic key of the ID application program generated using the first authentication key.

According to embodiments, the second security element further generates a fifth ephemeral symmetric cryptographic key using the shared first secret to encrypt the communication between the mobile terminal and the ID token.

Embodiments may have the advantage that an ephemeral symmetric cryptographic key may be provided with which the communication between the mobile terminal device and the ID token may be encrypted. This means, for example, that further communication between the IT token and the mobile terminal, the ID token communicating with the personalisation server in the course of setting up the second subchannel, may be encrypted. For example, the communication is encrypted with the corresponding ephemeral symmetric cryptographic key until the encrypted subchannel between the ID token and the personalisation server is established, which enables end-to-end encryption between the ID token and the personalisation server.

According to embodiments, establishing the first encrypted subchannel comprises authenticating the personalisation server by the ID token via the mobile terminal.

Embodiments may have the advantage that the participants establishing the encrypted subchannel may be sure with whom they are communicating. In particular, the ID token may thus be sure with whom it is communicating. For example, a corresponding authentication procedure is used to authenticate the personalisation server via the ID token.

According to embodiments, authenticating the personalisation server comprises using the ID token:
receiving a second certificate of the personalisation server, which comprises a second public cryptographic key of a second asymmetric cryptographic key pair of the personalisation server, via the encrypted communication channel,
verifying a signature of the received second certificate of the personalisation server,
generating a third random value by the ID token,
sending the third random value as a challenge to the personalisation server via the encrypted communication channel,
receiving a first signature of the challenge as a response from the personalisation server via the encrypted communication channel, whereby the challenge is signed using a second private cryptographic key of the personalisation server,
verify the received first signature using the second public cryptographic key of the personalisation server and the sent third random value.

According to embodiments, a second ephemeral public cryptographic key of the personalisation server, for example in compressed form, is further received by the ID token via the encrypted communication channel.

According to embodiments, a first data combination comprising the challenge is signed to generate the response. For example, the first data combination comprises the third random value sent as a challenge and the second ephemeral public cryptographic key of the personalisation server, for example in compressed form.

Embodiments may have the advantage that the personalisation server may be authenticated by the ID token in a cryptographically secure manner. For this purpose, the ID token receives a certificate from the personalisation server, for example, which provides a public cryptographic key from the personalisation server for authentication. The ID token verifies the signature of the received certificate. For example, the corresponding certificate is received as part of a certificate chain, for the verification of which corresponding signature verification keys, in particular root signature verification keys, are stored on the ID token. This enables the ID token to verify the authenticity of the certificate provided using the certificate chain, for example a PKI. Furthermore, the ID token receives, for example, an ephemeral public cryptographic key from the personalisation server. For example, the ID token receives the ephemeral public cryptographic key of the personalisation server in compressed form. In return for receiving the personalisation server's certificate, the ID token generates a random value, which it sends to the personalisation server as a challenge via the encrypted communication channel. The personalisation server uses a private cryptographic key, which forms an asymmetric key pair with the public cryptographic key of the previously provided certificate, to create a signature for the challenge as a response to the challenge. For example, to generate the response, a data combination is signed that includes the random value as a challenge and the ephemeral public cryptographic key of the personalisation server, for example in compressed form. The ID token receives the corresponding signature via the encrypted communication channel and verifies it using the previously received public cryptographic key of the personalisation server as the signature verification key. For this purpose, the ID token also uses, for example, the random value previously sent as a challenge and the previously received ephemeral public cryptographic key of the personalisation server.

According to embodiments, the first and second certificates of the personalisation server are different certificates with different public cryptographic keys of the personalisation server. Thus, in this case, the first and second public cryptographic keys of the personalisation server are, for example, different public cryptographic keys of different asymmetric cryptographic key pairs.

According to embodiments, the first and second certificates of the personalisation server are the same certificate with the same public cryptographic keys of the personalisation server. Thus, in this case, the first and second public cryptographic keys of the personalisation server are, for example, the same public cryptographic key of the same asymmetric cryptographic key pair.

According to embodiments, the second certificate of the personalisation server is a read certificate which proves that the personalisation server is authorised to read the first attributes to be read from the first ID token.

Embodiments may have the advantage that the personalisation server may prove read authorisation to read the attributes to be read from the ID token by means of the corresponding certificate.

According to embodiments, the second certificate of the personalisation server is received as part of a certificate chain, wherein verifying the signature of the received certificate comprises verifying a signature chain of the certificates of the certificate chain. According to embodiments, the certificate chain begins with an initial certificate that is signed by a root instance of which the signature may be verified with a root signature verification key stored in the ID token. According to embodiments, the certificate chain ends with the certificate of the personalisation server.

According to embodiments, the combination further comprises an identifier of the ID token, wherein the identifier of the ID token is further used to verify the received signature.

According to embodiments, the identifier of the ID token is generated, for example, using the ephemeral public cryptographic key of the ID token. For example, the identifier of the ID token is the compressed first ephemeral public cryptographic key of the ID token.

Embodiments may have the advantage that the ID token may be identified using the identifier. For example, an ephemeral public cryptographic key of the ID token may be used as the identifier of the ID token, which was previously generated, for example, in the course of authenticating the user to the ID token. The corresponding ephemeral public cryptographic key of the ID token can, for example, be forwarded from the mobile terminal to the personalisation server. This gives the personalisation server access to the corresponding ephemeral public cryptographic key, for example, and it may use this as an identifier to ensure that the ID token to which it authenticates itself is the same ID token to which the user of the mobile terminal previously authenticated himself.

According to embodiments, establishing the first encrypted subchannel comprises authenticating the ID token to the personalisation server via the mobile terminal.

Embodiments may have the advantage that a mutual authentication between ID token and personalisation server takes place in the course of establishing the encrypted subchannel.

According to embodiments, authenticating the ID token to personalisation servers:
sending the public cryptographic key of the ID token from the ID token to the personalisation server via the encrypted communication channel,
receiving the second ephemeral public cryptographic key of the personalisation server by the ID token from the personalisation server via the encrypted communication channel,
generating a second secret shared with the personalisation server by the ID token using the private cryptographic key of the ID token and the second ephemeral public cryptographic key of the personalisation server,
generating a fourth random value by the ID token,
generating a second common authentication key for authenticating data sent over the first encrypted subchannel by the ID token, wherein the second common authentication key is generated using the shared second secret and the fourth random value,
generating a third authentication token by the ID token using the second authentication key and the second ephemeral public cryptographic key of the personalisation server to authenticate the ID token to the personalisation server,
sending the fourth random value together with the third authentication token to authenticate the ID token by the ID token via the encrypted communication channel to the personalisation server.

Embodiments may have the advantage that the ID token may authenticate itself to the personalisation server in a cryptographically secure manner. For this purpose, the ID token sends a public cryptographic key to the personalisation server. This is done via the encrypted communication channel. In return, the ID token receives an ephemeral public cryptographic key from the personalisation server via the encrypted communication channel. The ID token computes a secret shared with the personalisation server using the private cryptographic key of the ID token and the received ephemeral public cryptographic key of the personalisation server. The personalisation server may compute the same shared secret using the ID token's public cryptographic key and the personalisation server's ephemeral private cryptographic key. The ID token generates a random value which it uses to calculate a shared authentication key. The authentication key is used to authenticate data that is sent via the encrypted subchannel. The ID token generates the corresponding shared authentication key using the random value and the shared secret. Furthermore, the ID token generates an authentication token using the corresponding authentication key and the ephemeral key of the personalisation server. The ID token sends the authentication token generated in this way together with the random value to the personalisation server in the communication channel. By receiving the random value, the personalisation server is also able to calculate the authentication key using the shared secret. With this shared authentication key and the personalisation server's ephemeral public cryptographic key, the personalisation server may verify the received authentication token. If the verification is successful, the ID token is also successfully authenticated against the personalisation server and a successful mutual authentication of ID token and personalisation server is achieved. Furthermore, the joint authentication key calculated in this way may be used to authenticate data that is exchanged between the ID token and the personalisation server via the encrypted subchannel.

According to embodiments, the ephemeral public cryptographic key of the personalisation server received in the course of authenticating the personalisation server, for example in compressed form, is compared with the ephemeral public cryptographic key of the personalisation server received in the course of authenticating the ID token, wherein a match between the two ephemeral public cryptographic keys of the personalisation server is a prerequisite for generating the shared second secret. For example, the ephemeral public cryptographic key of the personalisation server received in the course of authenticating the ID token is compressed for the purpose of comparison.

Embodiments may have the advantage that a binding may be established between the personalisation server and the authentication server communicated with in the course of authenticating the ID token.

According to embodiments, an application domain identifier of an application domain of the ID token is further used to generate the shared second secret, wherein the application domain identifier is sent from the ID token to the personalisation server together with the public cryptographic key of the ID token.

Embodiments may have the advantage that the ID token may be assigned to a specific area of application.

According to embodiments, the second authentication key is a cryptographic key for generating a message authentication code, wherein the second authentication token is a second MAC of the second ephemeral public cryptographic key of the personalisation server generated using the second authentication key.

According to embodiments, the ID token further generates the second channel-specific ephemeral symmetric cryptographic session key using the shared second secret and fourth random value.

Embodiments may have the advantage that a channel-specific ephemeral symmetric cryptographic session key may be provided for the subchannel in a cryptographically secure manner, which is only known to the ID token and the personalisation server. This enables end-to-end encryption via the encrypted subchannel between the ID token and the personalisation server.

According to embodiments, establishing the second encrypted subchannel comprises authenticating the user by the second security element. Establishing the second encrypted subchannel further comprises executing a challenge-response procedure between the second security element and the first security element. Successful execution of the challenge-response procedure confirms successful authentication of the user by the second security element.

Embodiments may have the advantage that after reading the attributes from the ID token before personalising the first security element, i.e. in the course of setting up the second channel, the user is first authenticated by the mobile terminal device. This authentication is performed on the first security element to be personalised by a further security element of the mobile terminal, which is assigned to the operating system of the mobile terminal and is configured for the authentication of the registered user of the mobile terminal using the authentication sensor of the mobile terminal. The corresponding additional security element authenticates the user and, following successful authentication, confirms the successful authentication to the personalising security element. This not only ensures that the personalisation is carried out on the same mobile terminal that has already been used to read the attributes from the ID token, but also that the personalisation is carried out with the consent of the registered user of the mobile terminal.

According to embodiments, the challenge-response method comprises, in response to an authentication request from the ID application program, authenticating the user by the operating system of the mobile terminal using the authentication sensor and the second security element, generating a response by the second security element, sending the response by the second security element to the first security element and validating the response by the first security element or the security applet, wherein generating the response comprises encrypting the challenge and wherein validating the response comprises decrypting the response.

The mobile terminal can, for example, serve as an authentication token, authorisation token and/or as proof of identity, i.e. ID token, for example in electronic business processes. For this purpose, the user may be securely authenticated by the mobile terminal. According to embodiments, the local authentication of the user by the terminal device may serve as a basis for further authentication of the user using identity attributes, for example stored on the mobile terminal device, for further authentication by an ID provider service.

The mobile terminal is configured for secure user authentication using the authentication sensor and the operating system or the second security element. Authentication can, for example, be based on capturing and analysing biometric characteristics of the user.

Embodiments may have the advantage that manufacturers of application programs or the corresponding application programs may use the authentication functionality of the mobile terminal for user authentication. The authentication functionality of the terminal device using the authentication sensor and the first security element implement a secure binding of the user with the terminal device. However, there is no secure binding of the terminal to the corresponding application program. Such a secure connection may be implemented by using the first security element with an applet of the application program. The second security element, which is for example a hardware-based security element of the device manufacturer, provides cryptographic means, such as cryptographic key material and protocols, which may be used for a secure provision of the authentication results of the user of the mobile terminal for an application program installed on the mobile terminal. Consequently, the second security element ensures the cryptographic security of the operating system or provides the operating system with cryptographic security functionality. According to embodiments, the second security element may also be a software-based and/or firmware-based security element of the device manufacturer, for example. The first security element, which securely communicates with the second security element using the challenge-response protocol and comprises the applet of the application program, may ensure a secure connection with the second security element. The first security element provides cryptographic means, such as cryptographic key material and protocols, which are assigned to the application program and are under its control and/or the control of the manufacturer of the application program. The first security element therefore ensures the cryptographic security of the application program or provides the application program with cryptographic security functionality. The second security element is, for example, a hardware-, software-and/or firmware-based security element. For example, the first security element comprises an eSIM or an eUICC.

Embodiments describe a method for the secure authentication of a user on a mobile terminal and the secure authentication of the user by a further security element on the corresponding mobile terminal with a device manufacturer-independent security application or security applet.

In particular, secure use of features for user authentication, such as biometric features, is made possible for authentication against a device manufacturer-independent application program or security applet of the application program.

According to embodiments, a challenge-response procedure is used to authenticate the user to the application program, which is executed between the operating system-assigned and therefore device-specific second security element and the device-independent first security element, which is not assigned to the operating system. The first security element or the security applet of the application program is, for example, an application-specific security element or security applet.

To implement the cryptographically secured connection between the first and second security element, cryptographic key material is inserted into and/or generated in the device manufacturer-dependent second security element, for example. This is done, for example, during initialisation of the mobile terminal. Furthermore, cryptographic key material is introduced into and/or generated in the device manufacturer-independent security applet of the first security element. This is done, for example, in the course of initialising the security applet or the first security element. The cryptographically initialised second security element may introduce a cryptographic key of the second security element into the security applet of the first security element or make it available to the first security element and/or the security applet of the first security element may introduce a cryptographic key of the security applet into the second security element or make it available to the second security element. The cryptographic key of the second security element is, for example, a public cryptographic key of an asymmetric cryptographic key pair of the second security element assigned to the application program. The cryptographic key of the security applet is, for example, a public cryptographic key of an asymmetric cryptographic key pair associated with the security applet. According to embodiments, a cryptographic secret, for example a cryptographic key, in particular a symmetric cryptographic key for executing the challenge-response procedure, is generated and transmitted. For example, the second security element generates the cryptographic secret and transmits it to the security applet in a cryptographically secure manner using the public cryptographic key provided by the security applet. For example, the security applet generates the cryptographic secret and transmits it to the second security element in a cryptographically secure manner using the public cryptographic key provided by the second security element.

Embodiments may have the advantage of providing a secure method for authenticating a user of the mobile terminal to the application program. The method makes it possible to authenticate the user of the mobile terminal using two security elements with respect to the application program or the security applet, which is assigned to the application program. The use of two independent security elements makes it possible to use a security element, i.e. the first security element, which is independent of the second security element and, for example, is not under the control of the device manufacturer, in addition to a security element, i.e. the second security element, which is assigned to the operating system and, for example, is under the control of the manufacturer of the mobile terminal. According to embodiments, the security applet of the first security element assigned to the application program is, for example, under the control of a manufacturer of the corresponding application program. The method thus also enables authentication of the user against the application program using the mobile terminal.

Embodiments may have the advantage that a simultaneous binding of the user to two independent security elements with a mutual secure interlocking of the two security elements is implemented on a mobile terminal. The binding of the user is implemented, for example, by the second security element having access to reference values for the one or more authentication factors of the user. For example, the corresponding reference values are stored in a memory area of the mobile terminal assigned to the second security element. For example, the security element comprises the corresponding memory area. For example, the reference values are stored outside the second security element. According to embodiments, the reference values are stored in a cryptographically secured form, for example in encrypted or hashed form. According to embodiments, the second security element is able to authenticate the user using authentication factors or authentication data recorded by the authentication sensor using the corresponding reference values. This allows the user to be bound to the second security element. The result of the authentication may be forwarded to the first security element in a cryptographically secure manner by means of the challenge-response method, whereby a binding of the user to the first security element may be implemented. As a result, the user may therefore be bound to both security elements simultaneously. The challenge-response method and the cryptographic means of the security elements on which it is based may thus be used to implement a mutually secure link between the two security elements on the mobile terminal. For example, the cryptographic means comprise a symmetric key, which is stored in the first security element and in the second security element and provides a cryptographic entanglement of the two security elements.

Authentication refers to the verification of a claimed property of an entity, such as a user of the mobile terminal. In the course of authentication, for example, a corresponding proof provided by the user is verified. The entity performs authentication by contributing to authentication, i.e. by providing corresponding evidence such as authentication data or authentication factors for verification.

Authentication of the user with regard to the claimed property of authenticity, for example the authenticity of their person or identity, allows the authenticated user to perform further actions. For example, the user is granted access rights. A successfully authenticated user is considered authentic. A final confirmation of an authentication may include an authorisation.

The user may authenticate himself in various ways. For example, they may provide proof of knowledge, such as a PIN or a password, proof of possession, such as a cryptographic key, a certificate or an electronic device, and/or proof of personal characteristics, such as biometric features or behavioural characteristics. For example, the corresponding proof is captured by an authentication sensor of the mobile terminal in the form of authentication data of one or more authentication factors of the user and compared by a security element of the mobile terminal with one or more stored reference values. The security element analysing the recorded authentication data is, for example, a security element of the operating system of the mobile terminal. If there is a sufficient match between the captured authentication data and the stored reference values, the security element confirms successful authentication of the user. For example, confirmation of successful authentication of the user includes execution of a challenge-response procedure by the confirming security element. For example, following successful authentication of the user, the confirming security element confirms this successful authentication to another security element of the mobile terminal, such as the security element with the security applet of the application program, by means of a correct response to a challenge from the corresponding other security element.

A mobile terminal is a mobile, portable communication device, such as a smartphone, tablet or smartwatch.

An authentication sensor is understood to be a sensor for recording authentication data of one or more authentication factors of the user of the mobile terminal. The authentication data may include, for example, biometric data of the user. The authentication sensor may be configured to capture biometric data of the user. Biometric data may include, for example: Fingerprint data, body geometry data/anthropometry data, such as face, hand, ear geometry data, hand line structure data, vein structure data, such as hand vein structure data, iris data, retina data, voice recognition data, nail bed pattern. The authentication sensor can, for example, comprise a camera of the mobile terminal. The authentication data may include, for example, knowledge of the user, such as a PIN or password. The authentication sensor may comprise an input device for entering authentication data, such as a PIN or a password. The input device may comprise, for example, a keyboard and/or a touch screen.

A challenge-response procedure represents a secure authentication procedure of a first instance towards a second instance on the basis of knowledge. For example, an authenticating security element of a mobile terminal, such as a security element of the operating system of the mobile terminal, is authenticated by another authenticating security element of the mobile terminal using a challenge-response procedure. At the same time, the response represents a confirmation of successful user authentication if the response is only generated under the condition of successful user authentication by the authenticating security element. Thus, in the event of a successful challenge-response procedure, the authenticating security element not only knows that the user authentication has been confirmed, but also that it has been confirmed by the authenticating security element and is therefore valid.

In a challenge-response procedure, a first instance issues a task (“challenge”) to a second instance, for which the second instance must provide a correct answer (“response”).

For example, the first instance generates a random number (“nonce”) and sends it to the second instance. The second instance uses, for example, a shared secret for a cryptographic transformation of the nonce and sends the result to the first instance as a response for the purpose of authenticating the second instance. For example, the nonce is combined with the shared secret and a cryptographic hash function or encryption is applied to this combination. Alternatively, the shared secret, such as a symmetric cryptographic key, may be used to encrypt the nonce. The first instance, which knows both the nonce and the shared secret, can, for example, perform the same calculation as the second instance and/or perform an inverse calculation, e.g. decrypt the encrypted nonce again using the shared secret. If the result of the calculation by the first instance matches the result of the calculation by the second instance or the challenge, the challenge-response procedure is successful and the second instance is successfully authenticated.

Furthermore, a challenge-response procedure may also be based on an asymmetric cryptosystem and serve to prove that the second instance possesses a private and therefore secret cryptographic key to the first instance. In this case, only the second instance knows the corresponding private cryptographic key, which it uses for a cryptographic transformation of the challenge, e.g. a nonce. The corresponding cryptographic transformation may be a digital signature, for example. Using a public cryptographic key associated with the private cryptographic key, the first instance may use the response to check whether the second instance actually has knowledge of the private cryptographic key without the first instance itself gaining knowledge of the private cryptographic key in the course of the check.

According to embodiments, the encryption and decryption is performed using a symmetric cryptographic key. According to embodiments, the encryption is performed using a private cryptographic key of an asymmetric cryptographic key pair of the first security element and the decryption is performed using a public cryptographic key of the asymmetric cryptographic key pair of the first security element.

According to embodiments, establishing the second encrypted subchannel further comprises authenticating the personalisation server by the security applet of the first security element.

Embodiments may have the advantage that a prerequisite for the establishment of the second encrypted subchannel is a successful authentication of the personalisation server by the security element. This means that the security element may not only be sure that the personalisation is performed by the same personalisation server that has read the attributes from the ID token, but also that the corresponding personalisation server is authorised to personalise the corresponding security element.

According to embodiments, authenticating the personalisation server by the security applet of the first security element comprises:
receiving a third certificate of the personalisation server, which comprises a third public cryptographic key of the personalisation server, by the security applet of the first security element via the encrypted communication channel,
verifying a signature of the received third certificate of the personalisation server by the security applet of the first security element,
generating a fifth random value by the security applet of the first security element,
sending the fifth random value as a challenge by the security applet of the first security element to the personalisation server via the encrypted communication channel,
receiving a second signature of the challenge as a response from the personalisation server, the challenge being signed using a third ephemeral private cryptographic key of the personalisation server,
verifying the received second signature using the third public cryptographic key of the personalisation server and the sent fifth random value.

According to embodiments, a third ephemeral public cryptographic key of the personalisation server, for example in compressed form, is further received by the security applet via the encrypted communication channel.

According to embodiments, a second data combination comprising the challenge is signed to generate the response. For example, in addition to the fifth random value sent as a challenge, the second data combination comprises the third ephemeral public cryptographic key of the personalisation server, for example in compressed form.

Embodiments may have the advantage that the first security element to be personalised first receives a certificate from the personalisation server via the encrypted communication channel. The corresponding certificate may be verified by the security element. For example, the corresponding certificate is provided as part of a certificate chain that may verify the security element with stored root signature verification keys. The ID token may therefore verify the authenticity of the certificate provided using the certificate chain, for example a PKI. Furthermore, the security element receives an ephemeral public cryptographic key from the personalisation server. For example, the security element receives the ephemeral public cryptographic key of the personalisation server in compressed form. In return for receiving the personalisation server's certificate, the security element generates a random value and sends the corresponding random value as a challenge to the personalisation server. In response to sending the random value as a challenge, the security element receives a signature of the challenge as a response from the personalisation server via the encrypted communication channel. To create the signature, the private cryptographic key of the personalisation server is used, which forms an asymmetric key pair with the public cryptographic key of the previously provided certificate. For example, a data combination is signed to generate the response. The corresponding data combination includes, for example, the random value previously sent as a challenge and the ephemeral public cryptographic key of the personalisation server, for example in compressed form. The security element may verify the corresponding signature using the previously received public cryptographic key of the personalisation server as a signature verification key. For this purpose, the security element also uses, for example, the ephemeral public cryptographic key of the personalisation server and the random value previously sent as a challenge. If the signature check is successful, the personalisation server is considered successfully authenticated.

According to embodiments, the first, second and/or third certificates of the personalisation server are different certificates with different public cryptographic keys of the personalisation server. Thus, in this case, the first, second and/or third public cryptographic keys of the personalisation server are, for example, different public cryptographic keys of different asymmetric cryptographic key pairs.

According to embodiments, the first, second and/or third certificate of the personalisation server is the same certificate with the same public cryptographic key of the personalisation server. Thus, in this case, the first, second and/or third public cryptographic key of the personalisation server is, for example, the same public cryptographic key of the same asymmetric cryptographic key pair.

According to embodiments, the certificate is received as part of a certificate chain, wherein verifying the signature of the received certificate comprises verifying a signature chain of the certificates of the certificate chain. According to embodiments, the certificate chain starts with an initial certificate which is signed by a root instance of which the signature may be verified with a root signature verification key to which the security applet of the first security element has access. According to embodiments, the certificate chain ends with the certificate of the personalisation server.

According to embodiments, establishing the second encrypted subchannel further comprises authenticating the security applet of the first security element to the personalisation server.

Embodiments may have the advantage that authentication of the security element is carried out with respect to the personalisation server. Thus, for example, mutual authentication may be implemented between the security applet to be personalised and the personalisation server.

According to embodiments, authenticating the security applet of the first security element to the personalisation server:
receiving the third ephemeral public cryptographic key of the personalisation server by the security applet of the first security element from the personalisation server via the encrypted communication channel,
generating a third secret shared with the personalisation server by the security applet of the first security element using the private cryptographic key of the security applet of the first security element and the ephemeral public cryptographic key of the personalisation server,
generating a sixth random value by the security applet of the first security element,
generating a third common authentication key for authenticating data sent over the second encrypted subchannel, wherein the third common authentication key is generated using the shared third secret and the sixth random value,
generating a fourth authentication token by the security applet of the first security element using the third authentication key and the third ephemeral public cryptographic key of the personalisation server to authenticate the security applet of the first security element to the personalisation server,
sending the sixth random value together with the fourth authentication token to authenticate the security applet of the first security element by the security applet of the first security element via the encrypted communication channel to the personalisation server.

Embodiments may have the advantage that the security applet of the first security element that has not yet been personalised may authenticate itself to the personalisation server. For this purpose, the corresponding security applet to be personalised first uses a stored initial cryptographic key of the security applet. This initial cryptographic key is, for example, an initial private cryptographic key. The corresponding initial cryptographic key is stored on the first security element in the course of provisioning the security applet, for example. For example, an initial asymmetric key pair is stored. To authenticate the security applet, the corresponding security applet first receives, for example, an ephemeral n public cryptographic key generated for the purpose of authentication from the personalisation server. The personalisation server generates the corresponding ephemeral public cryptographic key, for example for authenticating the security applet to be personalised. The security applet receives the ephemeral public cryptographic key on the first security element, for example via the encrypted communication channel. The security applet calculates a shared secret using the initial private cryptographic key of the security applet and the received ephemeral public cryptographic key of the personalisation server. The security applet to be personalised generates a random value. The security applet to be personalised uses the corresponding random value to generate a shared authentication key. The shared secret is also used to generate the corresponding shared authentication key. The security applet also generates an authentication token. The security applet generates the corresponding authentication token using the previously received ephemeral public cryptographic key of the personalisation server and the previously generated shared authentication key. The security applet to be personalised sends this authentication token together with the random value to the personalisation server via the encrypted communication channel. The personalisation server may also initially calculate the shared secret. To do this, the personalisation server uses an initial public cryptographic key of the security applet, which is known to the personalisation server. This was stored on the personalisation server, for example, when the ID application program was registered during provisioning. For example, the corresponding initial public cryptographic key was generated in the course of provisioning the security applet to be personalised and made available to the personalisation server. Furthermore, the personalisation server uses the ephemeral private cryptographic key of the personalisation server to calculate the shared secret. With the corresponding shared secret, the personalisation server is able to calculate the shared authentication key. To do this, the personalisation server uses the received random value and the previously calculated shared secret. This enables the personalisation server to verify the received authentication token using the shared authentication key and the personalisation server's ephemeral public cryptographic key.

This allows the security applet to be personalised to be authenticated. This may have the advantage, for example, that the participants in the encrypted subchannel between the security applet of the first security element to be personalised and the personalisation server know who they are communicating with or may ensure that they are communicating with the correct participant. Furthermore, the shared authentication key may be used to authenticate data that is exchanged between the security applet to be personalised and the personalisation server via the second encrypted subchannel.

According to embodiments, the ephemeral public cryptographic key of the personalisation server received in the course of authenticating the personalisation server is compared with the ephemeral public cryptographic key of the personalisation server received in the course of authenticating the security applet of the first security element, wherein a match of both ephemeral public cryptographic keys of the personalisation server is a prerequisite for generating the shared secret.

According to embodiments, the third authentication key is a cryptographic key for generating a message authentication code, wherein the third authentication token is a third MAC of the third ephemeral public cryptographic key of the personalisation server generated using the third authentication key.

According to embodiments, the security applet of the first security element further generates the third channel-specific ephemeral symmetric cryptographic session key using the shared third secret and the sixth random value.

Embodiments may have the advantage that a channel-specific ephemeral symmetric cryptographic session key may be provided for the security element to be personalised and the personalisation server, by means of which the second subchannel may be encrypted. In particular, end-to-end encryption may thus be implemented between the endpoints of the corresponding subchannel, i.e. the security element to be personalised and the personalisation server.

According to embodiments, the third channel-specific ephemeral symmetric cryptographic session key for encrypting the second encrypted subchannel between the security applet of the first security element and the personalisation server is stored in the first security element and in the personalisation server as an initial key for use by the security applet.

For example, the security applet for personalisation is provided by the personalisation server in a sub-security domain of the first security element, which is otherwise empty and, for example, does not include any key material for mutual authentication with the personalisation server. In this case, for example, no corresponding mutual authentication with the personalisation server takes place in the course of setting up the second encrypted subchannel. Instead, for example, only the initial key for use by the security applet is stored in the first security element.

According to embodiments, the first security element for use by the security applet and the personalisation server further includes a channel-specific ephemeral symmetric cryptographic authentication key for authenticating data transmitted via the corresponding second encrypted subchannel.

According to embodiments, a plurality of ID tokens are used for personalisation.

According to embodiments, a second ID token is further used for the personalisation. The personalisation further comprises:
establishing a third encrypted subchannel between the second ID token and the personalisation server within the encrypted communication channel via the mobile terminal, using the ID application program to establish the third encrypted subchannel,
reading out one or more of the second attributes from the second ID token by the personalisation server via the third encrypted subchannel within the encrypted communication channel,
establishing a fourth encrypted subchannel between the security applet of the first security element and the personalisation server within the encrypted communication channel, wherein the ID application program is used to establish the fourth encrypted subchannel,
receiving, by the security applet of the first security element, the read-out second attributes from the personalisation server via the fourth encrypted subchannel within the encrypted communication channel,
storing the received second attributes by the security applet, whereby the ID application program is configured to use the second attributes to prove the identity of the user to another computer system.

Embodiments may have the advantage that attributes may be read from different ID tokens and stored in the security element of the mobile terminal to be personalised in the course of personalisation. This means that not only digital identities that reflect identities provided by an ID token, i.e. an electronic identity document, may be stored on the mobile terminal, but also identities that represent combinations of attributes from corresponding ID tokens. For example, the attributes from different ID tokens are read out via the same encrypted communication channel.

For example, attributes are read from different ID tokens via different encrypted communication channels. According to embodiments, a third encrypted communication channel is established between the mobile terminal and the personalisation server via the network, within which a third and fourth encrypted subchannel is established.

For example, the ID application program is configured to use the second attributes in combination with the first attributes to prove the identity of the user to another computer system.

According to embodiments, the ID application program is configured to send one or more of the first and/or second attributes of the user to another terminal device.

According to embodiments, the ID application program is configured to send one or more of the first and/or second attributes of the user via the network to an ID provider server for provisioning to a service provider server and/or for confirmation to the service provider server using a communication interface of the mobile terminal.

Embodiments further comprise a mobile terminal comprising a processor and a memory. An ID application program is stored in the memory. The mobile terminal further comprises a security element with a security applet associated with the ID application program. The processor is configured to execute a method for personalising the security applet using an ID token and a personalisation server. Furthermore, the mobile terminal also comprises a communication interface for contactless communication with the ID token and for communication via a network with the personalisation server.

The personalisation comprises:
establishing an encrypted communication channel between the mobile terminal and the personalisation server via a network, using the ID application program to establish the encrypted communication channel,
establishing a first encrypted subchannel between the first ID token and the personalisation server within the encrypted communication channel via the mobile terminal, using the ID application program to establish the first encrypted subchannel,
reading out one or more of the first attributes from the ID token by the personalisation server via the first encrypted subchannel within the encrypted communication channel,
establishing a second encrypted subchannel between the security applet of the security element and the personalisation server within the encrypted communication channel, using the ID application program to establish the second encrypted subchannel,
receiving, by the security applet of the security element, the read-out attributes from the personalisation server via the second encrypted subchannel within the encrypted communication channel,
storing the received attributes by the security applet, whereby the ID application program is configured to use the attributes to prove the identity of the user to another computer system.

According to embodiments, the mobile terminal is configured to perform each of the previously described embodiments of the method for personalising a security applet.

Embodiments further comprise a system. The system comprises a mobile terminal and a personalisation server. The personalisation server is configured to read out attributes from an ID token via the mobile terminal and to personalise the security applet of the mobile terminal.

According to embodiments, the system is configured to perform each of the embodiments of the method for personalising a security applet described above.

According to embodiments, the system further comprises the ID token in which the attributes to be read out are stored.

In the following, embodiments of the invention are explained in greater detail with reference to the drawings, in which:

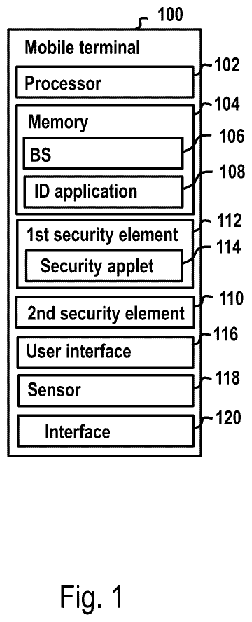

FIG. 1 shows a schematic diagram of an exemplary mobile terminal device,

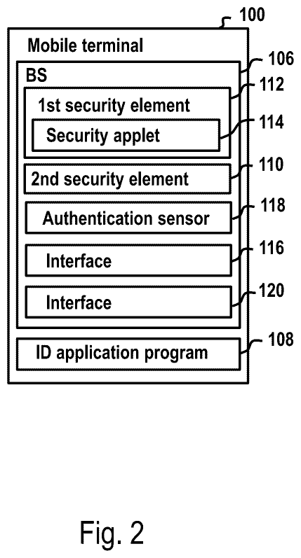

FIG. 2 shows a schematic diagram of an exemplary mobile terminal device,

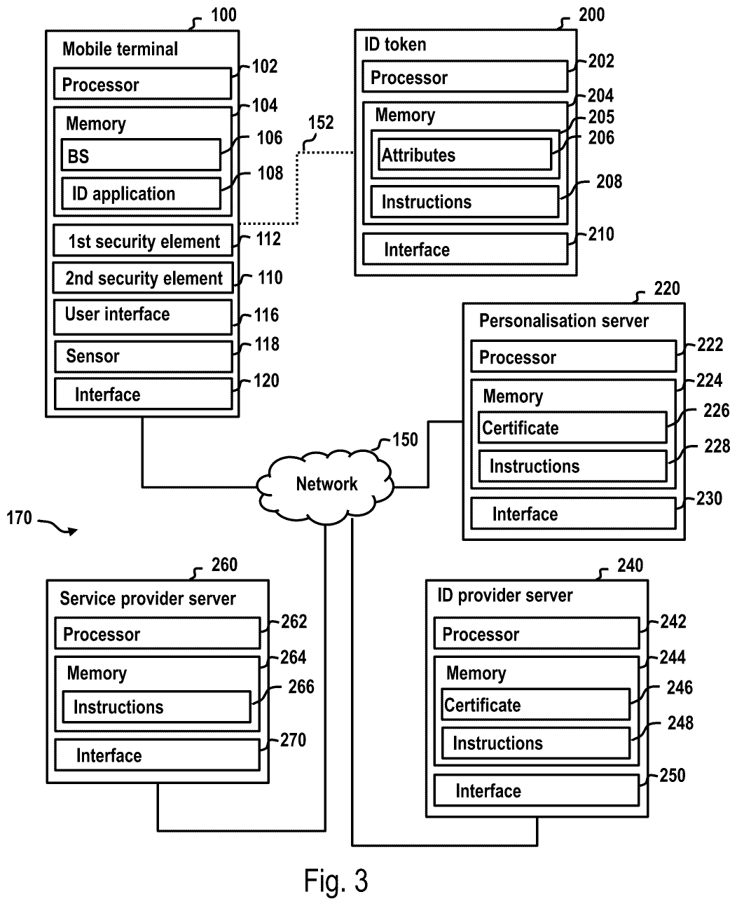

FIG. 3 shows a schematic diagram of an exemplary system,

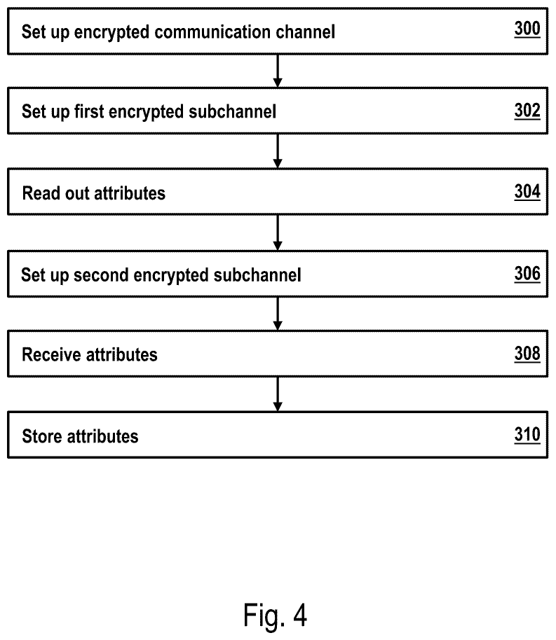

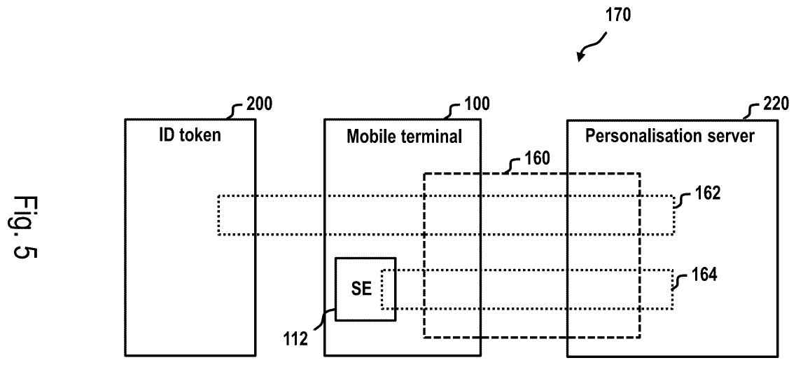

FIG. 4 shows a flowchart of an exemplary procedure for personalising a security applet,

FIG. 5 shows a schematic diagram of exemplary encrypted channels, and

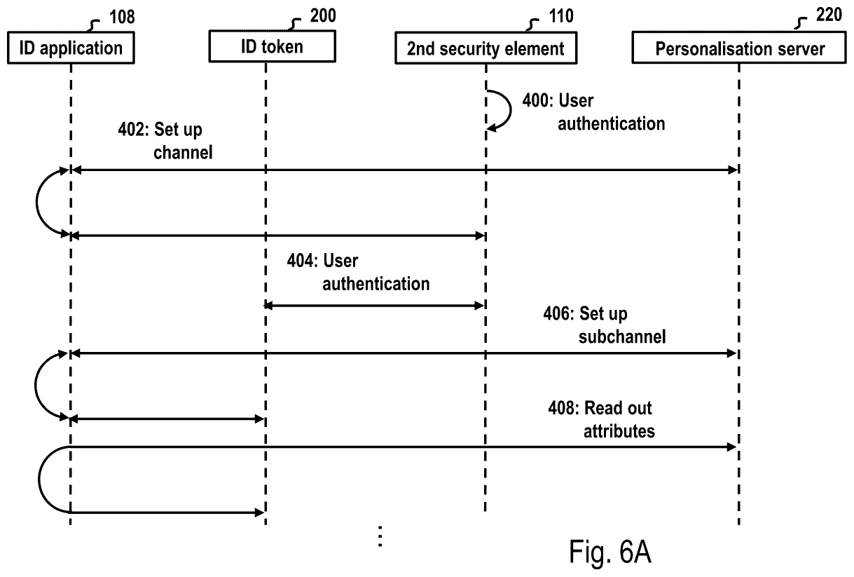

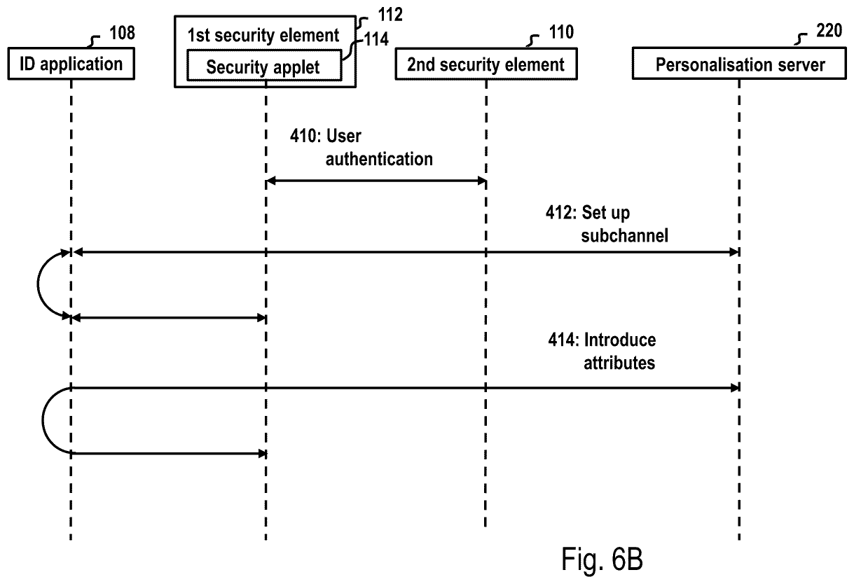

FIGS. 6A, B show a flowchart of an exemplary method for personalising the security applet.

Elements of the following embodiments that correspond to one another are labelled with the same reference signs.

FIG. 1 shows an exemplary mobile terminal 100, for example a smartphone, which comprises a memory 104 with program instructions which are executed by a processor 102. The program instructions may comprise, for example, an operating system 106 installed on the mobile terminal 100 and an ID application program 108. The ID application program 108 is configured to manage attributes or identity attributes of a user in a personalised state and, for example, to provide evidence of an identity of the user to another computer system. Furthermore, the ID application program 108 comprises, for example, a personalisation component that controls the personalisation of a security applet 114 associated with the ID application program 108. In particular, the personalisation component controls, for example, an establishment of encrypted channels for communication in the course of a corresponding personalisation. The corresponding attributes are part of or form an electronic identity of the user managed by the ID application program 108, which the user may use by means of the mobile terminal 100.

Furthermore, the mobile terminal 100 comprises, for example, two security elements 110, 112, each of which may be implemented as an eSIM and/or eUICC, for example. One of the two security elements 110 is associated with the operating system 106 and provides cryptographic means for the latter, such as cryptographic keys, cryptographic functions and/or cryptographic protocols. For example, the security element 110 provides a key store or key memory for storing cryptographic keys, such as symmetric, public and/or private cryptographic keys, and certificates, such as read certificates, public key certificates and/or attribute certificates. The cryptographic means provided by the security element 110 enable the operating system 106 to execute or participate in a challenge response procedure. For example, the security applet 114 associated with the ID application program 108 is installed on the other security element 112. This security applet 114 provides cryptographic means for the ID application program 108, such as cryptographic keys, cryptographic functions and/or cryptographic protocols. The security applet 114 or a memory area of the security element 112 associated with the security applet 114 provides, for example, a key store or key storage for storing cryptographic keys, such as symmetric, public and/or private cryptographic keys, and certificates, such as read certificates, public key certificates and/or attribute certificates. The cryptographic means provided by the security element 112 enabled the ID application program 108 to execute or participate in a challenge response procedure. For example, such a challenge response procedure serves to confirm a successful user authentication by the security element 110 to the ID application program 108 or the security applet 114 of the security element 112, which is assigned to the application program 108. Furthermore, the mobile terminal 100 comprises a user interface 116, which comprises, for example, a display, in particular a touchscreen. Using the user interface 116, the user may interact with the mobile terminal 100. For example, the user may be prompted to provide authentication factors or authentication features. To capture authentication data of the user's authentication factors, the mobile terminal 100 comprises an authentication sensor 118, which may, for example, be integrated into the user interface 116 or implemented as a stand-alone component. Finally, the mobile terminal 100 comprises a communication interface or antenna 120, which is configured for wireless communication, for example via a network.

Using the communication interface 120, the mobile terminal 100 can, for example, communicate with a personalisation server for the purpose of personalising the security applet 114 in the security element 112 and thus the ID application program 108. Furthermore, the communication interface 120 is configured, for example, to communicate wirelessly with an ID token that provides the attributes of the user. For different communication methods, the communication interface 120 comprises, for example, different communication components. The mobile terminal 100 with the communication interface 120 may therefore act as a transceiver to enable communication between the ID token and the personalisation server for reading the attributes from the ID token by the personalisation server. The mobile terminal 100 uses the security element 110 to establish an encrypted communication channel to the personalisation server via a network. The corresponding communication channel is encrypted, for example using end-to-end encryption. Within the encrypted communication channel, a first encrypted subchannel is established between the ID token and the personalisation server using the mobile terminal 100 or a personalisation component of the ID application program 108. The corresponding first subchannel is also encrypted using end-to-end encryption, for example. This first encrypted subchannel is used, for example, for communication between the ID token and the personalisation server, for example for reading the attributes provided by the ID token by the personalisation server. Furthermore, a second encrypted subchannel may be established within the encrypted communication channel between the security applet 114 of the security element 112 to be personalised and the personalisation server. The establishment takes place, for example, again with the mediation of the personalisation component of the ID application program 108. The corresponding second subchannel is also encrypted, for example, using end-to-end encryption. This second encrypted subchannel is used, for example, for communication between the security applet 114 of the security element 112 and the personalisation server, for example for personalising the security applet 114 with the attributes read from the ID token by the personalisation server.

FIG. 2 shows an exemplary mobile terminal 100 on which an operating system 106 is installed, which manages the resources of the mobile terminal 100 and makes them available to the ID application program 108. The managed resources include, for example, the two security elements 110, 112, the authentication sensor 118, the user interface 116 and the communication interface 120. Although the security element 112 is provided or managed by the operating system 106, for example, the security applet 114 comprised by the corresponding security element 112 is assigned to the ID application program 108, i.e. the security applet 114 only provides cryptographic resources to the ID application program 108. The operating system 106 cannot use these cryptographic means. For cryptographic tasks, for example in the course of using the authentication sensor 118 or the communication interface 120, the other security element 110 with its cryptographic means is instead available to the operating system 106.

FIG. 3 shows an exemplary system 170, which comprises a mobile terminal 100 that is connected to a personalisation server 220 via a network 150, for example the Internet. In addition, the mobile terminal 100 may communicate via the network 150 with, for example, an ID provider server 240 and/or a service provider server 260. Furthermore, the mobile terminal 100 may be connected to an ID token 200, for example, via a wireless direct communication link 152. The mobile terminal 100 is structured, for example, as described in FIG. 1 and has the corresponding functionalities. To personalise the security applet of the security element 112, attributes 206 are used, for example, which are provided by an ID token 200. The ID token 200 comprises a processor 202 and a memory 204. The attributes 206, which are identity attributes of the holder of the ID token 200, are stored in a protected memory area 205 of the memory 204. Furthermore, program instructions 208 are stored in the memory 204, the execution of which by the processor 202 causes the processor to enable the attributes 206 to be read by an authorised instance, such as the personalisation server 220. For this purpose, the ID token 200 establishes a wireless direct connection 152 with the mobile terminal 100 using its communication interface 210, for example, via which the personalisation server 220 may read out the attributes 206.

The personalisation server 220 comprises a processor 222, a memory 224 and a communication interface 230. Program instructions 228 are stored in the memory 224, during the execution of which the processor 222 controls the personalisation server 220 to establish encrypted channels with the mobile terminal 100, the ID token 200 via the mobile terminal 100 and with the security applet in the security element 112 of the mobile terminal 100. The personalisation server 220 uses these channels to read out attributes 206 from the ID token 200 and insert the read-out attributes 206 into the security element 112 in the course of personalisation. The personalisation server 220 uses, for example, corresponding certificates 226 to verify read authorisation for the attributes 206 from the ID token 200 and write authorisation for writing the read-out attributes 206 to the security element 112 of the mobile terminal 100.

Furthermore, the system comprises, for example, a service provider server 260. The service provider server 260 comprises a processor 262, a memory 264 and a communication interface 270. Program instructions 268 are stored in the memory 264, during the execution of which the processor 262 controls the service provider server 260 to provide services which may be requested and/or used, for example, by the mobile terminal 100 via the network 150. Utilisation of services of the service provider server 260 requires, for example, provision and/or verification of one or more identity attributes of the user. In response to a request for a service of the service provider server 260 by the mobile terminal device 100, the service provider server 260 sends an identity attribute request for identity attributes of the user of the mobile terminal device 100 to an ID provider server 240. The identity attribute request may be sent by the service provider server 260 to the ID provider server 240, for example, directly or via the mobile terminal device 100.

The ID provider server 240 comprises a processor 242, a memory 244 and a communication interface 250. Program instructions 248 are stored in the memory 244, during the execution of which the processor 242 instructs the service provider server 240 to read the identity attributes specified in the identity attribute request from a memory of the mobile terminal 100. For this purpose, the ID provider server 240 establishes a cryptographically secured communication channel with the mobile terminal 100. The one cryptographically secured communication channel may, for example, be an end-to-end encrypted communication channel. For example, this requires mutual authentication of the ID provider server 240 and the mobile terminal 100. For read access to the identity attributes, the ID provider server 240 uses an ID application program 108 on the mobile terminal 100, which manages the identity attributes. The ID provider server 240 verifies read authorisation to read the identity attributes specified in the identity attribute request, for example with the authorisation certificate 248. Furthermore, read access by the ID provider server 240 to the identity attributes specified in the identity attribute request requires the consent of the user of the mobile terminal 100. For this purpose, the user must successfully authenticate himself to the ID application program 108. For example, a display device of the user interface 116 indicates to the user which identity attribute is to be sent to the ID provider server 240 and allows the user to edit this selection. For example, the user may select which of the requested identity attributes are actually sent. Upon successful proof of read authorisation and successful user authentication, the approved identity attributes are sent to the ID provider server 240. The ID provider server 240 signs the received identity attributes and sends them to the service provider server 260.

FIG. 4 shows an exemplary procedure for personalising a security applet. The security applet to be personalised is installed on a security element of a mobile terminal and assigned to an ID application program installed on the mobile terminal. Personalisation is carried out using an ID token, on which attributes of a user are stored, and a personalisation server, which has both authorisation to read the attributes from the ID token and authorisation to insert the read-out attributes into the security applet for the purpose of personalisation. The personalisation server verifies the corresponding authorisations using certificates and/or the possession and use of certain cryptographic keys.

In block 300, personalisation involves setting up an encrypted communication channel between the mobile terminal and the personalisation server via a network. Here, for example, the ID application program or a personalisation component of the ID application program is used to control the setup. In the course of the setup, for example, the mobile terminal and personalisation server are mutually authenticated, for example using challenge-response procedures. Furthermore, for example, a first channel-specific ephemeral symmetric cryptographic session key for encrypting the communication channel is negotiated between the mobile terminal and the personalisation server.

In block 302, a first encrypted subchannel is established between the ID token and the personalisation server within the encrypted communication channel via the mobile terminal. Here, for example, the ID application program or a personalisation component of the ID application program is used to control the setup. During the setup process, the ID token and personalisation server authenticate each other, for example using challenge-response procedures. Furthermore, for example, a second channel-specific ephemeral symmetric cryptographic session key for encrypting the first subchannel is negotiated between the ID token and the personalisation server. In block 304, one or more of the attributes are read from the ID token by the personalisation server via the first encrypted subchannel within the encrypted communication channel.

Furthermore, in block 306, a second encrypted subchannel is set up between the security applet of the security element and the personalisation server within the encrypted communication channel. Here, for example, the ID application program or a personalisation component of the ID application program is used to control the setup. In the course of the setup, for example, mutual authentication of the ID application program or the associated security applet and the personalisation server takes place, for example using challenge-response procedures. Furthermore, for example, a third channel-specific ephemeral symmetric cryptographic session key for encrypting the second subchannel is negotiated between the security applet and the personalisation server. In block 308, the security applet receives the read-out attributes from the personalisation server via the second encrypted subchannel within the encrypted communication channel. In block 310, the security applet stores the received attributes, with which it is assigned or personalised to the corresponding user. The ID application program is configured to use the stored attributes to prove the electronic identity of the corresponding user to another computer system. In the course of personalisation, the personalisation server also initiates, for example, the generation of an asymmetric cryptographic key pair assigned to the ID application program by the security applet. The asymmetric cryptographic key pair comprises a private cryptographic key and a public cryptographic key of the ID application program, which are used, for example, to authenticate the ID application program in the course of using the attributes. The public cryptographic key of the ID application program is sent, for example, by the security applet to the personalisation server via the second encrypted subchannel within the encrypted communication channel. Furthermore, the security applet receives, for example, one or more root signature verification keys from the personalisation server via the second encrypted subchannel within the encrypted communication channel. These received root signature verification keys are stored and are used to verify certificate signatures of one or more root instances, which have certificates that are used to authenticate a reading computer system to the ID application program in the course of reading the first attributes. In addition, the security applet receives and stores, for example, a signature of the received attributes from the personalisation server via the second encrypted subchannel within the encrypted communication channel. The signature serves as proof of the authenticity of the attributes, especially if the attributes are used for the purpose of proof of identity in offline mode.

FIG. 5 shows exemplary encrypted channels 160, 162, 164, which are established on the security element 112 in the course of personalising the security applet. An encrypted communication channel 160 is established between the mobile terminal 100 and the personalisation server 220. This serves to secure the communication between the mobile terminal 100 and the personalisation server 220, and at the same time binds the mobile terminal 100 to the personalisation server 220 in the course of communication. The personalisation server 220 may thus ensure that all communication via the encrypted communication channel 160 takes place via the same mobile terminal 100. For example, the same mobile terminal 100 is used to read out attributes from the ID token, which is subsequently personalised with the read-out attributes.

In the course of further personalisation, communication between the mobile terminal 100 and the personalisation server 220 takes place via the encrypted communication channel 160. This also includes communication between the personalisation server 220 and the ID token 200, which takes place via the mobile terminal 100. The encrypted communication channel 160 is encrypted using end-to-end encryption, for example. Encryption and decryption of the communication takes place on the side of the mobile terminal 100, for example by means of the further security element of the operating system of the mobile terminal 100. Within the encrypted communication channel 160, a first encrypted subchannel 162 is also established between the ID token 200 and the personalisation server 220 with the mediation of the mobile terminal 100 or a personalisation component of the ID application program. This first encrypted subchannel 162 is used, for example, for communication between the ID token 200 and the personalisation server 220, for example for reading out the attributes provided by the ID token 200 by the personalisation server 220. The corresponding first subchannel 162 is also encrypted, for example, using end-to-end encryption. The data transmission between mobile terminal 100 and personalisation server 220 takes place, for example, via a network, while the data transmission between mobile terminal 100 and ID token 200 takes place, for example, via a direct wireless connection.

In this context, subchannel means that data to be transmitted via the corresponding subchannel is first encrypted using a cryptographic session key of the corresponding subchannel. For example, a MAC of the data is also generated using a cryptographic authentication key of the corresponding subchannel and transmitted together with the encrypted data. In addition, the data to be transmitted is encrypted using a further cryptographic session key of the communication channel, which is superordinate to the subchannel. For example, a further MAC of the data is also generated using a further cryptographic authentication key of the corresponding communication channel and transmitted together with the encrypted data. If the transmitted data reaches the end of the communication channel, the encryption of the communication channel is decrypted first. If the transmitted data then reaches the end of the subchannel, the encryption of the subchannel is also decrypted. Transmission via an encrypted subchannel within an encrypted communication channel therefore involves double encryption with two independent session keys. The session keys are independent in the sense that access to one of the two session keys does not automatically result in access to the other session key.

Within the encrypted communication channel 160, a second encrypted subchannel 164 is also established between the security element 112 or a security applet 114 of the security element 112 to be personalised and the personalisation server 220, with the personalisation component of the ID application program acting as an intermediary. The corresponding second subchannel 164 is also encrypted using end-to-end encryption, for example. This second encrypted subchannel 164 is used, for example, for communication between the security element 112 and the personalisation server 220, for example for personalising the security applet 114 of the security element 112 with the attributes read from the ID token 200 by the personalisation server 220.

FIG. 6, which comprises FIGS. 6A and 6B, shows an exemplary method for personalising a security applet 114 in a security element 112. First, in step 400, a user of the mobile terminal device authenticates himself to a security element 110 of the mobile terminal device 100 configured for this purpose. For example, reference values for one or more authentication factors, such as biometric features or a PIN, of a user registered on the mobile terminal device are stored in the security element 110. In the course of user authentication, one or more authentication factors of the user are recorded and compared with the reference values. In the event of a match, for example, the user is deemed to have been successfully authenticated. In step 402, an encrypted communication channel is established between the mobile terminal, for example the security element 110, and the personalisation server 220. This comprises, for example, mutual authentication of the mobile terminal or security element 110 and personalisation server 220, for example by means of a challenge-response method, and negotiation of a cryptographic key, for example a channel-specific ephemeral symmetric cryptographic session key, for encrypting the communication channel.

For example, a first initial random value is first generated by the mobile terminal or the security element 110 and sent to the personalisation server 220. After receiving the corresponding first initial random value, the personalisation server 220 generates a second initial random value, which it sends to the mobile terminal 100. Thus, both participants, the mobile terminal and the personalisation server 220, have both initial random values. Furthermore, the server sends its certificate to the mobile terminal, for example, and receives a certificate of the mobile terminal from the mobile terminal after a successful check of the corresponding certificate. The certificate of the mobile terminal may, for example, be a certificate associated with the application program. The certificate of the mobile terminal received by the personalisation server 220 is also verified. The two certificates each comprise a public cryptographic key, i.e. the certificate of the personalisation server 220 comprises a public cryptographic key of an asymmetric key pair of the personalisation server 220 and the certificate of the mobile terminal comprises a public cryptographic key of an asymmetric key pair of the mobile terminal. Thus, both participants now each have public cryptographic keys of the other party, the authenticity of which is proven by a certificate. The mobile terminal then generates the first random value, for example, which it sends to the personalisation server 220. Thus, both participants in the communication now each have three random values from which, for example, the channel-specific ephemeral symmetric cryptographic session key may be calculated. Furthermore, the mobile terminal sends, for example, a signature of one, several or all previous messages exchanged in the course of establishing the channel to the personalisation server 220. The personalisation server 220 may authenticate the mobile terminal by verifying the corresponding signature using the public cryptographic key provided in the certificate of the mobile terminal as a signature verification key. If the personalisation server 220 subsequently sends a message encrypted with the first channel-specific ephemeral symmetric cryptographic session key to the mobile terminal device, the personalisation server 220 is thereby also authenticated with respect to the mobile terminal device. The personalisation server 220 may only calculate the first channel-specific ephemeral symmetric cryptographic session key if it has a private cryptographic key with which it may decrypt the first random value received from the mobile terminal. Thus, only the personalisation server 220 in possession of the corresponding private cryptographic key, to which the certificate of the personalisation server 220 is assigned, is capable of encrypted communication via the encrypted communication channel.

To enable the establishment of a first encrypted subchannel, in step 404 the user of the mobile terminal device is authenticated by the ID token 200 using the mobile terminal device or the security element 110. For example, the user is authenticated to the ID token 200 using the mobile terminal device. For example, an ephemeral symmetric cryptographic key is derived using the captured authentication factor of the user. The mobile terminal receives a random value from the ID token 200, which is encrypted with the same ephemeral symmetric cryptographic key. The ID token 200 derives the corresponding ephemeral symmetric cryptographic key, for example, from a reference value for the authentication factor or the correspondingly derived ephemeral symmetric cryptographic key is stored on the ID token 200. If the mobile terminal is able to correctly decrypt the received encrypted random value, this constitutes proof that the mobile terminal has the correct authentication factor. The mobile terminal generates an ephemeral asymmetric key pair, the public cryptographic key of which the mobile terminal sends to the ID token 200. In return, the mobile terminal receives the public cryptographic key of the ID token 200. At this point in the procedure, therefore, no static cryptographic keys are required; instead, only randomly generated ephemeral asymmetric key pairs may be used. The mobile terminal generates a secret shared with the ID token 200 using the decrypted random value, the ephemeral private cryptographic key of the ID application program and the ephemeral public cryptographic key of the ID token 200. The ID token 200 is also capable of calculating the corresponding secret using the random value generated by it, the ephemeral private cryptographic key of the ID token 200 and the ephemeral public cryptographic key of the mobile terminal received from the mobile terminal.

The mobile terminal device may now use the shared secret thus generated to calculate a shared authentication key for mutual authentication of the ID application program and ID token 200. For example, the mobile terminal device may generate a first authentication token using the corresponding authentication key and the ephemeral public cryptographic key of the ID token 200. The corresponding authentication token may be sent from the mobile terminal device to the ID token 200, which may verify the received authentication token using the shared authentication key and the ephemeral private cryptographic key of the ID token 200. In this way, the mobile terminal may authenticate itself to the ID token 200. In return, the ID token 200 may also send an authentication token to the mobile terminal. The mobile terminal receives the authentication token, which is generated, for example, using the shared secret and the ephemeral public cryptographic key of the mobile terminal. The authentication token may be verified using the authentication key and the public cryptographic key of the ID application program.

In step 406, a first encrypted subchannel is established upon successful authentication of the user in step 404. The establishment of the first encrypted subchannel comprises, for example, a mutual authentication of ID token 200 and personalisation server 220 and a negotiation of a cryptographic key for encrypting the corresponding subchannel.

For example, the personalisation server 220 is first authenticated by the ID token 200 in a cryptographically secure manner. For this purpose, the ID token 200 receives, for example, a certificate from the personalisation server 220, which provides a public cryptographic key of the personalisation server 220 for authentication. The ID token 200 verifies the signature of the received certificate. For example, the corresponding certificate is received as part of a certificate chain, for the verification of which corresponding signature verification keys, in particular root signature verification keys, are stored on the ID token 200. The ID token 200 may therefore verify the authenticity of the certificate provided using the certificate chain, for example a PKI. Furthermore, the ID token 200 receives, for example, an ephemeral public cryptographic key of the personalisation server 220. For example, the ID token 200 receives the ephemeral public cryptographic key of the personalisation server 220 in compressed form. In return for receiving the certificate of the personalisation server 220, the ID token 200 generates a random value, which it sends to the personalisation server 220 as a challenge via the encrypted communication channel. Using a private cryptographic key, which forms an asymmetric key pair with the public cryptographic key of the previously provided certificate, the personalisation server 220 creates a signature of the challenge as a response to the challenge. For example, to generate the response, a data combination is signed which comprises the random value as a challenge and the ephemeral public cryptographic key of the personalisation server 220, for example in compressed form. The ID token 200 receives the corresponding signature via the encrypted communication channel and verifies it using the previously received public cryptographic key of the personalisation server 220 as the signature verification key. For this purpose, the ID token 200 also uses, for example, the random value previously sent and the ephemeral public cryptographic key of the personalisation server 220 previously received as a challenge.

The ID token 200 then authenticates itself to the personalisation server 220 in a cryptographically secure manner. For this purpose, the ID token 200 sends a public cryptographic key to the personalisation server 220. This is done via the encrypted communication channel. In return, the ID token 200 receives an ephemeral public cryptographic key from the personalisation server 220 via the encrypted communication channel. The ID token 200 computes a shared secret with the personalisation server 220 using the private cryptographic key of the ID token 200 and the received ephemeral public cryptographic key of the personalisation server 220. The personalisation server 220 may compute the same shared secret using the public cryptographic key of the ID token 200 and the ephemeral private cryptographic key of the personalisation server 220. The ID token 200 generates a random value which it uses to compute a shared authentication key. The authentication key is used to authenticate data sent via the encrypted subchannel. The ID token 200 generates the corresponding shared authentication key using the random value and the shared secret. Further, the ID token 200 generates an authentication token using the corresponding authentication key and the ephemeral key of the personalisation server 220. The authentication token thus generated is sent by the ID token 200 together with the random value to the personalisation server 220 in the communication channel. By receiving the random value, the personalisation server 220 is also enabled to calculate the authentication key using the shared secret. Using this shared authentication key and the ephemeral public cryptographic key of the personalisation server 220, the personalisation server 220 may verify the received authentication token. If the verification is successful, the ID token 200 is also successfully authenticated to the personalisation server 220 and a successful mutual authentication of the ID token 200 and the personalisation server 220 is realised. Furthermore, the joint authentication key calculated in this way may be used to authenticate data that is exchanged between ID token 200 and personalisation server 220 via the encrypted subchannel.

Further, the ID token 200 and the personalisation server 220 may each individually generate the channel-specific ephemeral symmetric cryptographic session key for encrypting the first subchannel using the shared secret and the random value.

In step 408, the personalisation server 220 uses the first encrypted subchannel thus established between the personalisation server 220 and the ID token 200 within the encrypted communication channel between the personalisation server 220 and the mobile terminal device or the security element 110 to read the attributes from the ID token 200 via the mobile terminal device.

A second encrypted subchannel is established between the security applet 114 of the security element and the personalisation server 220 in order to introduce the read-out attributes. In step 410, for example, the user is authenticated by the security element 110, which confirms the successful authentication to the security applet of the security element 112, for example by means of a challenge-response procedure.

In step 412, a second encrypted subchannel is established upon successful authentication of the user in step 410. The establishment of the second encrypted subchannel comprises, for example, mutual authentication of security applets and personalisation server 220 and negotiation of a cryptographic key for encrypting the corresponding subchannel.

First, for example, the personalisation server 220 is authenticated by the first security element 112 or the security applet 114 in a cryptographically secure manner. For this purpose, the security element 112 to be personalised first receives a certificate from the personalisation server 220 via the encrypted communication channel. The corresponding certificate may be verified by the security element 112. For example, the corresponding certificate is provided as part of a certificate chain that may verify the security element 112 with stored root signature verification keys. Thus, the security element 112 may verify the authenticity of the provided certificate using the certificate chain, for example a PKI. Further, the security element 112 receives an ephemeral public cryptographic key of the personalisation server 220. For example, the security element 112 receives the ephemeral public cryptographic key of the personalisation server 220 in a compressed form. In return for receiving the certificate from the personalisation server, the security element 112 generates a random value and sends the corresponding random value as a challenge to the personalisation server 220. In response to sending the random value as a challenge, the security element 112 receives a signature of the challenge as a response from the personalisation server 220 via the encrypted communication channel. To create the signature, the private cryptographic key of the personalisation server 220 is used, which forms an asymmetric key pair with the public cryptographic key of the previously provided certificate. For example, a data combination is signed to generate the response. The corresponding data combination comprises, for example, the random value previously sent as a challenge and the ephemeral public cryptographic key of the personalisation server 220, for example in compressed form. The security element 112 may verify the corresponding signature using the previously received public cryptographic key of the personalisation server 220 as a signature verification key. For this purpose, the security element 112 further uses, for example, the ephemeral public cryptographic key of the personalisation server 220 and the random value previously sent as a challenge. If the signature check is successful, the personalisation server 220 is deemed to have been successfully authenticated.

Subsequently, the security element 112 or the security applet 114 authenticates itself to the personalisation server 220 in a cryptographically secure manner. For this purpose, the corresponding security element 112 or the security applet 114 to be personalised first uses a stored initial private cryptographic key of the security applet 114. The corresponding initial private cryptographic key is stored on the security element 112, for example, in the course of provisioning the security applet 114. For example, an asymmetric cryptographic key pair of the security applet 114 comprising the initial private cryptographic key is stored. To authenticate the security applet 114, the corresponding security applet 114 first receives, for example, an ephemeral public cryptographic key generated for the purpose of authentication from the personalisation server 220. The corresponding ephemeral public cryptographic key is generated by the personalisation server 220, for example, to authenticate the security applet 114 to be personalised. The ephemeral public cryptographic key is received by the security applet 114, for example, via the encrypted communication channel. The security applet 114 112 computes a shared secret using the initial private cryptographic key of the security applet 114 and the received ephemeral public cryptographic key of the personalisation server 220. The security applet 114 to be personalised generates a random value. The security applet 114 to be personalised uses the corresponding random value to generate a shared authentication key. The shared secret is also used to generate the corresponding shared authentication key. In addition, the security applet 114 generates an authentication token. The corresponding authentication token is generated by the security applet 114 using the previously received ephemeral public cryptographic key of the personalisation server 220 and the previously generated shared authentication key. The security applet 114 to be personalised sends this authentication token together with the random value to the personalisation server 220 via the encrypted communication channel. The personalisation server 220 may also initially calculate the shared secret. For this purpose, the personalisation server 220 uses an initial public cryptographic key of the security applet 114, which is known to the personalisation server 220. For example, the corresponding initial public cryptographic key was generated in the course of provisioning the security applet 114 to be personalised and made available to the personalisation server 220. Further, the personalisation server 220 uses the ephemeral private cryptographic key of the personalisation server 220 to compute the shared secret. With the corresponding shared secret, the personalisation server 220 is able to calculate the shared authentication key. For this purpose, the personalisation server 220 uses the received random value and the previously calculated shared secret. Thus, the personalisation server 220 may verify the received authentication token using the shared authentication key and the ephemeral public cryptographic key of the personalisation server 220.

Further, the security applet 114 of the security element 112 and the personalisation server 220 may each individually generate the channel-specific ephemeral symmetric cryptographic session key for encrypting the second subchannel using the shared secret and the random value. The second encrypted subchannel thus established between the personalisation server 220 and the security applet 114 of the security element 112 within the encrypted communication channel is used by the personalisation server 220 in step 414 to introduce the attributes from the ID token 200 into the security applet 114 of the first security element 112 to be personalised.

### LIST OF REFERENCE SIGNS

100 mobile terminal device
102 processor
104 memory
106 operating system
108 ID application program
110 security element
112 security element
114 security applet
116 user interface
118 authentication sensor
120 communication interface
150 network
160 encrypted communication channel
162 encrypted subchannel
164 encrypted subchannel
170 system
200 ID token
202 processor
204 memory
205 protected memory area
206 attributes
208 program instructions
210 communication interface
220 personalisation server
222 processor
224 memory
226 certificate
228 program instructions
230 communication interface
240 ID provider server
242 processor
244 memory
246 certificate
248 program instructions
250 communication interface
260 service provider server
262 processor
264 memory
266 program instructions
270 communication interface

1. A method for personalising a security applet installed on a first security element of a mobile terminal, using a first ID token and a personalisation server, wherein an ID application program is installed on the mobile terminal, to which the security applet is assigned, wherein first attributes of a user are stored in the first ID token,
wherein the personalisation comprises:
establishing an encrypted communication channel between the mobile terminal and the personalisation server via a network, wherein the ID application program is used to establish the encrypted communication channel,
establishing a first encrypted subchannel between the first ID token and the personalisation server within the encrypted communication channel via the mobile terminal, wherein the ID application program is used to establish the first encrypted subchannel,
reading out one or more of the first attributes from the first ID token by the personalisation server via the first encrypted subchannel within the encrypted communication channel,
establishing a second encrypted subchannel between the security applet of the first security element and the personalisation server within the encrypted communication channel, wherein the ID application program is used to establish the second encrypted subchannel,
receiving, by the security applet of the first security element, the read-out first attributes from the personalisation server via the second encrypted subchannel within the encrypted communication channel,
storing the received first attributes by the security applet, wherein the ID application program is configured to use the first attributes to prove an identity of the user to another computer system.

2. The method according to claim 1, wherein the encrypted communication channel is encrypted with a first channel-specific ephemeral symmetric cryptographic session key, wherein the first encrypted subchannel is encrypted with a second channel-specific ephemeral symmetric cryptographic session key, wherein the second encrypted subchannel is encrypted with a third channel-specific ephemeral symmetric cryptographic session key.

3. The method according to claim 1, wherein the encryption of the encrypted communication channel is an end-to-end encryption between the mobile terminal and the personalisation server.

4. The method according to claim 1, wherein the encryption of the first encrypted subchannel is an end-to-end encryption between the first ID token and the personalisation server.

5. The method according to claim 1, wherein the encryption of the second encrypted subchannel is an end-to-end encryption between the security applet and the personalisation server.

6. The method according to claim 1, wherein the personalisation further comprises:
generating an asymmetric cryptographic key pair associated with the ID application program by the security applet of the first security element comprising a private cryptographic key and a public cryptographic key of the ID application program, wherein the asymmetric key pair is used to authenticate the ID application program in the course of using the first attributes.

7. The method according to claim 1, wherein the personalisation further comprises:
receiving one or more root signature verification keys by the security applet of the first security element from the personalisation server via the second encrypted subchannel within the encrypted communication channel, wherein the received root signature verification keys are for verifying certificate signatures of one or more root instances having certificates each used in the course of a readout of the first attributes for authenticating a reading computer system to the ID application program,
storing the received root signature verification keys by the security applet in the first security element.

8. The method according to claim 1, wherein the personalisation further comprises:
receiving a signature of the first attributes from the personalisation server by the security applet of the first security element via the second encrypted subchannel within the encrypted communication channel, wherein the signature serves as proof of authenticity of the first attributes,
storing the received signature of the first attributes by the security applet in the first security element.

9. The method according to claim 2, wherein establishing the encrypted communication channel comprises negotiating the first channel-specific ephemeral symmetric cryptographic session key.

10-13. (canceled)

14. The method according to claim 1, wherein establishing the first encrypted subchannel comprises authenticating the user to the ID token via the mobile terminal.

15-16. (canceled)

17. The method according to claim 1, wherein establishing the first encrypted subchannel comprises authenticating the personalisation server by the ID token via the mobile terminal.

18-19. (canceled)

20. The method according to claim 1, wherein establishing the first encrypted subchannel comprises authenticating the ID token to the personalisation server via the mobile terminal.

21-22. (canceled)

23. The method according to claim 1, wherein establishing the second encrypted subchannel comprises authenticating the user by the second security element, wherein establishing the second encrypted subchannel further comprises executing a challenge-response procedure between the second security element and the first security element, wherein a successful execution of the challenge-response procedure confirms a successful authentication of the user by the second security element.

24. The method according to claim 1, wherein establishing the second encrypted subchannel further comprises authenticating the personalisation server by the security applet of the first security element.

25. (canceled)

26. The method according to claim 1, wherein establishing the second encrypted subchannel further comprises authenticating the security applet of the first security element to the personalisation server.

27-28. (canceled)

29. The method according to claim 1, wherein the third channel-specific ephemeral symmetric cryptographic session key for encrypting the second encrypted subchannel between the security applet of the first security element and the personalisation server is stored in the first security element and in the personalisation server as an initial key for use by the security applet.

30. (canceled)

31. The method according to claim 1, wherein a second ID token is further used for the personalisation, wherein the personalisation further comprises:
establishing a third encrypted subchannel between the second ID token and the personalisation server within the encrypted communication channel via the mobile terminal, wherein the ID application program is used to establish the third encrypted subchannel,
reading out one or more of the second attributes from the second ID token by the personalisation server via the third encrypted subchannel within the encrypted communication channel,
establishing a fourth encrypted subchannel between the security applet of the first security element and the personalisation server within the encrypted communication channel, wherein the ID application program is used to establish the fourth encrypted subchannel,
receiving the read-out second attributes by the security applet of the first security element from the personalisation server via the fourth encrypted subchannel within the encrypted communication channel,
storing the received second attributes by the security applet, wherein the ID application program is configured to use the second attributes to prove an identity of the user to another computer system.

32. A mobile terminal, wherein the mobile terminal comprises a processor and a memory, wherein the memory stores an ID application program, wherein the mobile terminal further comprises a security element having a security applet associated with the ID application program, wherein the processor is configured to carry out a method for personalising the security applet using an ID token and a personalisation server, wherein the mobile terminal further comprises a communication interface for contactless communication with the ID token and for communication via a network with the personalisation server,
wherein the personalisation comprises:
establishing an encrypted communication channel between the mobile terminal and the personalisation server via a network, wherein the ID application program is used to establish the encrypted communication channel,
establishing a first encrypted subchannel between the first ID token and the personalisation server within the encrypted communication channel via the mobile terminal, wherein the ID application program is used to establish the first encrypted subchannel,
reading out one or more of the first attributes from the ID token by the personalisation server via the first encrypted subchannel within the encrypted communication channel,
establishing a second encrypted subchannel between the security applet of the security element and the personalisation server within the encrypted communication channel, wherein the ID application program is used to establish the second encrypted subchannel,
receiving the read-out attributes by the security applet of the security element from the personalisation server via the second encrypted subchannel within the encrypted communication channel,
storing the received attributes by the security applet, wherein the ID application program is configured to use the attributes to prove an identity of the user to another computer system.

33. A system, wherein the system comprises a mobile terminal according to claim 18 and a personalisation server, wherein the personalisation server is configured to read out attributes from an ID token via the mobile terminal and to personalise the security applet of the mobile terminal.

34. The system according to claim 19, wherein the system further comprises the ID token in which the attributes to be read out are stored.
